(19) United States
(12) Patent Application Publication
(10) Pub. No.: US 2025/0068941 A1
(43) Pub. Date: Feb. 27, 2025

(54) MODEL TRAINING

(71) Applicant: Tencent Technology (Shenzhen) Company Limited, Shenzhen (CN)

(72) Inventors: Jiawei ZHENG, Shenzhen (CN); Hao GU, Shenzhen (CN); Lingling YI, Shenzhen (CN)

(73) Assignee: Tencent Technology (Shenzhen) Company Limited, Shenzhen (CN)

(21) Appl. No.: 18/943,817

(22) Filed: Nov. 11, 2024

Related U.S. Application Data
(63) Continuation of application No. PCT/CN2023/128606, filed on Oct. 31, 2023.

(30) Foreign Application Priority Data
Nov. 29, 2022 (CN) 202211507481.6

(51) Int. Cl. G06N 5/022; G06F 18/25

(52) U.S. Cl. CPC G06N 5/022; G06F 18/253

(57) ABSTRACT

A method of model training includes obtaining a data set for training an interest alignment model of cross domain recommendation, the data set includes first domain data and second domain data. The method also includes performing a first feature extraction on the first domain data according to the interest alignment model to obtain a first domain feature representation and performing a second feature extraction on the second domain data according to the interest alignment model to obtain a second domain feature representation. Further, the method includes performing an interest alignment between the first domain and the second domain according to the interest alignment model based on the first domain feature representation and the second domain feature representation; and training the interest alignment model in a direction that reduces at least one of a first loss and a second loss, to obtain a trained interest alignment model.

### RELATED APPLICATIONS

The present application is a continuation of International Application No. PCT/CN2023/128606, filed on Oct. 31, 2023, which claims priority to Chinese Patent Application No. 202211507481.6, filed on Nov. 29, 2022. The entire disclosures of the prior applications are hereby incorporated by reference.

### FIELD OF THE TECHNOLOGY

This disclosure relates to the field of computer technologies, including the field of machine learning (ML).

### BACKGROUND OF THE DISCLOSURE

A personalized recommender system is a platform configured to recommend personalized resources to a user (that is, an object). For example, a personalized recommender system in a video scenario supports recommendations of video resources of interest to a user.

Currently, a personalized recommender system supports construction of a resource recommendation model by collecting a large amount of behavioral data (such as interaction data between user data and resource data) of a user (that is, an object) and by using a designed recommendation algorithm, to generate a specific recommendation list for the object through the constructed resource recommendation model, thereby achieving a goal of personalized recommendations. However, in practice, it is found that the personalized recommender system does not have rich data of all objects. In this case, the resource recommendation model obtained through training based on a large amount of interaction data of the objects is not suitable for making resource recommendations to objects with less interaction data, resulting in a poor recommendation effect of the resource recommendation model.

### SUMMARY

Embodiments of this disclosure provide a model training method and apparatus, an electronic device, a computer-readable storage medium, and a computer program product. An interest alignment model can be trained by using an interest relationship between objects, to ensure performance of the interest alignment model.

In some examples, a method of model training includes obtaining a data set for training an interest alignment model of cross domain recommendation. The data set includes first domain data of one or more objects in a first domain and second domain data of the one or more objects in a second domain. The first domain includes first resources, the second domain includes second resources, the first domain data includes respective first resources of interest to the one or more objects, and the second domain data includes respective second resources of interest to the one or more objects. The method also includes performing a first feature extraction on the first domain data according to the interest alignment model to obtain a first domain feature representation and performing a second feature extraction on the second domain data according to the interest alignment model to obtain a second domain feature representation. Further, the method includes performing an interest alignment between the first domain and the second domain according to the interest alignment model based on the first domain feature representation and the second domain feature representation; and training the interest alignment model in a direction that reduces at least one of a first loss and a second loss, to obtain a trained interest alignment model. The first loss is associated with at least one of the first feature extraction and the second feature extraction, the second loss is associated with the interest alignment, and the trained interest alignment model is configured to make a resource data recommendation to a target object in the second domain.

In some example, an electronic device is provided. The electronic device includes processing circuitry that is configured to obtain a data set for training an interest alignment model of cross domain recommendation. The data set includes first domain data of one or more objects in a first domain and second domain data of the one or more objects in a second domain. The first domain includes first resources. The second domain includes second resources. The first domain data includes respective first resources of interest to the one or more objects, and the second domain data includes respective second resources of interest to the one or more objects. The processing circuitry is configured to perform a first feature extraction on the first domain data according to the interest alignment model to obtain a first domain feature representation. The processing circuitry is configured to perform a second feature extraction on the second domain data according to the interest alignment model to obtain a second domain feature representation. The processing circuitry is configured to perform an interest alignment between the first domain and the second domain according to the interest alignment model based on the first domain feature representation and the second domain feature representation. The processing circuitry is configured to train the interest alignment model in a direction that reduces at least one of a first loss and a second loss, to obtain a trained interest alignment model. The first loss is associated with at least one of the first feature extraction and the second feature extraction, the second loss is associated with the interest alignment, and the trained interest alignment model is configured to make a resource data recommendation to a target object in the second domain.

An embodiment of this disclosure provides a model training method, performed by an electronic device, the method including:
obtaining a data set, the data set including first domain data and second domain data, the first domain data including at least one object and first resource data of interest to each object in a first domain, and the second domain data including the at least one object and second resource data of interest to each object in a second domain;
calling an interest alignment model to perform feature extraction on the first domain data to obtain a first domain feature representation; and calling the interest alignment model to perform feature extraction on the second domain data to obtain a second domain feature representation;
calling the interest alignment model to perform the following processing: performing interest alignment processing between the first domain and the second domain based on the first domain feature representation and the second domain feature representation; and
training the interest alignment model according to a direction in which a first loss and a second loss are reduced, to obtain a trained interest alignment model,
the first loss being a loss corresponding to the feature extraction, the second loss being a loss corresponding to the interest alignment processing, and the trained interest alignment model being configured for making a resource data recommendation to a target object in the second domain.

An embodiment of this disclosure provides a model training apparatus. The apparatus includes:
an obtaining unit, configured to obtain a data set, the data set including first domain data and second domain data, the first domain data including at least one object and first resource data of interest to each object in a first domain, and the second domain data including the at least one object and second resource data of interest to each object in a second domain; and
a processing unit, configured to: call an interest alignment model to perform feature extraction on the first domain data to obtain a first domain feature representation; and call the interest alignment model to perform feature extraction on the second domain data to obtain a second domain feature representation;
the processing unit being further configured to call the interest alignment model to perform the following processing: performing interest alignment processing between the first domain and the second domain based on the first domain feature representation and the second domain feature representation; and
the processing unit being further configured to train the interest alignment model according to a direction in which a first loss and a second loss are reduced, to obtain a trained interest alignment model,
the first loss being a loss corresponding to the feature extraction, the second loss being a loss corresponding to the interest alignment processing, and the trained interest alignment model being configured for making a resource data recommendation to a target object in the second domain.

An embodiment of this disclosure provides an electronic device. The electronic device includes:
a processor (also referred to as processing circuitry in some examples), configured to load and execute a computer-executable instruction; and
a computer-readable storage medium (also referred to as non-transitory computer-readable storage medium in some examples), the computer-readable storage medium having the computer-executable instruction stored therein, and the foregoing model training method being implemented when the computer-executable instruction is executed by the processor.

An embodiment of this disclosure provides a computer-readable storage medium, the computer-readable storage medium having the computer-executable instruction stored therein, and the computer-executable instruction being adapted to be loaded and executed by a processor to implement the foregoing model training method.

An embodiment of this disclosure provides a computer program product. The computer program product includes a computer-executable instruction. The computer-executable instruction is stored in a computer-readable storage medium. A processor of an electronic device reads the computer-executable instruction from the computer-readable storage medium. When the computer-executable instruction is executed by the processor, the foregoing model training method is implemented.

In the embodiments of this disclosure, obtaining resource data of interest to at least one object in a corresponding domain from a plurality of domains to form a data set, for example, obtaining first domain data from a first domain and obtaining second domain data from a second domain, is supported, where the first domain is a domain with rich interaction data, and the second domain may be a domain with scarce interaction data. Then, an interest alignment model is called to perform feature extraction on the first domain data and the second domain data separately to extract a first domain feature representation and a second domain feature representation. The interest alignment model is called to perform interest alignment processing in the two domains based on the first domain feature representation and the second domain feature representation; and finally, training of the interest alignment model according to a direction of reducing a first loss of the feature extraction process and a loss of the interest alignment processing process is supported. The embodiments of this disclosure fully consider an interest similarity degree between objects, and support training of the interest alignment model in a manner of aligning the interest similarity degree between the objects, so that even when the interest alignment model is applied to a domain with little interaction data, an accurate feature representation can still be produced for an object. For example, considering that there is much interaction data in the first domain, the first domain feature representation extracted based on rich interaction data is more accurate. Therefore, the interest alignment model is trained in a manner of aligning an interest similarity degree between two objects in the second domain with little interaction data with an interest similarity degree between the two objects in the first domain with much interaction data. It can be ensured that the trained interest alignment model can still produce a feature representation with high accuracy for an object even when the interaction data in the second domain is little, so that the resource data recommended to the object based on the accurate feature representation satisfies the personalized needs of the object, and an accurate recommendation of resources is implemented. In the embodiments of this disclosure, a manner of jointly training the interest alignment model by using the first loss of the feature extraction process and the loss of the interest alignment processing process can enrich an overall learning objective of the interest alignment model, and ensure performance of the interest alignment model through multi-objective learning.

### BRIEF DESCRIPTION OF THE DRAWINGS

To describe the technical solutions in the embodiments of this disclosure more clearly, the following briefly introduces the accompanying drawings for describing the embodiments.

FIG. 1a is a schematic diagram of an architecture of a resource recommendation system according to an embodiment of this disclosure.

FIG. 1b is a schematic diagram of an architecture of another resource recommendation system according to an embodiment of this disclosure.

FIG. 2 is a schematic diagram of a model structure of an interest alignment model according to an embodiment of this disclosure.

FIG. 3 is a schematic flowchart of a model training method according to an embodiment of this disclosure.

FIG. 4 is a schematic diagram of constructing an object resource graph of a second domain according to an embodiment of this disclosure.

FIG. 5 is a schematic diagram of a graph encoding learning architecture according to an embodiment of this disclosure.

FIG. 6 is a schematic diagram of performing interest alignment processing between a first domain and a second domain according to an embodiment of this disclosure.

FIG. 7 is a schematic diagram of performing interest alignment processing in each of a first domain and a second domain according to an embodiment of this disclosure.

FIG. 8 is a schematic diagram of a graph reconstruction according to an embodiment of this disclosure.

FIG. 9 is a schematic flowchart of another model training method according to an embodiment of this disclosure.

FIG. 10 is a schematic diagram of performing matching between a fused feature representation of a target object and a resource feature representation of each candidate resource data according to an embodiment of this disclosure.

FIG. 11 is a schematic structural diagram of a model training apparatus according to an embodiment of this disclosure.

FIG. 12 is a schematic structural diagram of an electronic device according to an embodiment of this disclosure.

### DESCRIPTION OF EMBODIMENTS

The technical solutions in the embodiments of this disclosure are described in the following with reference to the accompanying drawings. The embodiments to be described are merely a part rather than all of the embodiments of this disclosure. Other embodiments obtained by persons of ordinary skill in the art based on the embodiments of the present disclosure shall fall within the protection scope of the present disclosure.

In the embodiments of this disclosure, a model training solution is provided, and specifically, a training and application solution of an interest alignment model in a resource recommendation scenario is provided. The following briefly introduces technical terms and related concepts involved in the model training solution provided in the embodiments of this disclosure. The descriptions of the terms are provided as examples only and are not intended to limit the scope of the disclosure.

### 1. Artificial Intelligence (AI).

AI involves a theory, a method, a technology, and an application system that use a digital computer or a machine controlled by the digital computer to simulate, extend, and expand human intelligence, perceive an environment, obtain knowledge, and use knowledge to obtain an optimal result. The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, and ML/deep learning. ML is a multi-field interdiscipline, relates to a plurality of disciplines such as the probability theory, statistics, the approximation theory, convex analysis, and the algorithm complexity theory, specializes in studying how a computer simulates or implements a human learning behavior to obtain new knowledge or skills, and reorganize an existing knowledge structure, to keep improving its performance. ML and deep learning generally include technologies such as an artificial neural network, a belief network, reinforcement learning, transfer learning, inductive learning, learning from demonstrations, and meta learning.

The model training solution provided in the embodiments of this disclosure mainly involves an artificial neural network in ML and transfer learning. The following briefly describes the artificial neural network and the transfer learning separately.

(1) An artificial neural network is a method for implementing a task of ML. A neural network discussed in the field of ML is generally referred to as “neural network learning”. It is a network structure composed of many simple elements. The network structure is similar to a biological neural system and is configured to simulate interaction between a living being and a natural environment. More network structures indicate richer functions of the neural network. The neural network is a relatively large concept, and for different learning tasks such as speech, text, and images, neural network models that are more suitable for specific learning tasks, such as graph neural networks (GNNs), are derived. The GNN is an algorithm that uses a deep learning model to perform feature mining and extraction on graph structure data; and is specifically a collective name of algorithms that can satisfy graph learning task requirements such as clustering, classification, prediction, segmentation, and generation by learning the graph structure data, and extracting and discovering features and patterns in the graph structure data. For example, the GNN that satisfies the above graph learning task requirements may include, but is not limited to: a graph convolutional network (GCN), a graph recurrent network (GRN), a graph attention network (GAT), and the like.

The embodiments of this disclosure specifically relate to a GAT included in a GNN. The GAT includes an attention mechanism. Through the attention mechanism, the neural network can pay attention to only information required for task learning to select specific input. In other words, introducing an attention mechanism into the GAT can cause the neural network to pay attention to graph structure data (such as nodes and edges included in the graph) that is more task-related, thereby improving effectiveness of training and precision of testing. The attention mechanism is generated by simulating human visual attention. For example, the field of view of human eyes is relatively open, but there is usually only a small range for the focus to which the field of view pays attention. In other words, the human eyes pay more attention to an important region (that is, a region of interest) in the field of view. Therefore, similar to human visual attention, the attention mechanism aims to pay attention to important information in a task and ignore unimportant information. The attention mechanism may be further subdivided into a self-attention mechanism, a multi-head self-attention mechanism, a global attention mechanism, and the like.

(2) The transfer learning is a commonly used technology for coping with insufficient training data and/or annotation. Specifically, a learned new task is improved by transferring knowledge from a learned related task, for example, a parameter of a model that is pre-trained (using data and annotation of a non-current task) is transferred (copied) to a new network model to assist in training. Although most ML algorithms are designed to resolve a single task, development of algorithms to facilitate transfer learning is a topic to which the ML community continuously pays attention.

The transfer learning involves the concept of a domain. The domain is the main body of the transfer learning and is composed of data features and feature distribution. In a resource recommendation scenario, domains are generally used to refer to different application fields, such as shopping, a movie, reading a book, a video, a social public account, a document, and live streaming. As can be learned from the foregoing descriptions, a task of the transfer learning is to apply a model learned by an old domain to a new domain starting from a similarity between problems. Therefore, the domain involved in the transfer learning usually includes at least two domains, namely, a source domain and a target domain. The source domain is a domain different from a domain to which sample data (that is, resource data) of a to-be-trained model belongs. The source domain usually includes rich supervisory information (that is, rich resource data for model training). The target domain is a domain that is the same as the domain to which the sample data of the to-be-trained model belongs. The target domain usually includes only a small amount of resource data for model training.

### 2. Resource Recommendation.

The resource recommendation is also referred to as resource distribution, and may refer to a process of distributing, on a resource recommendation platform (or a resource recommendation system, or the aforementioned personalized recommender system), resource data included in the platform to a platform object (for example, one or more resource recipients registered with a platform account or temporarily logged in to the platform). The resource data included in the resource recommendation platform may be referred to as Internet resources (or resources for short), including but not limited to videos (which may be divided into long videos and short videos according to time lengths of the videos), audio (such as music or voice audio), animations, documents (such as journals or treatises), or the like. The resource type of the resource data is not limited in the embodiments of this disclosure. The resource type of the resource data is related to the domain to which the resource recommendation platform that distributes the resource data belongs (that is, the foregoing domain). The resource types of the resource data distributed by different domains may be different. For example, the resource type of the resource data in the live streaming domain is a video, and the resource type of the resource data in the document domain is a document. The resource type of the resource data is not limited in the embodiments of this disclosure.

The resource recommendation platform may refer to an application program that supports distributing or recommending resource data. The application program may be a computer program that completes one or more specific jobs. Application programs are classified according to different dimensions (such as running manners and functions of the application programs), and types of the same application program in different dimensions can be obtained. For example, when being classified according to running manners of the application programs, the application programs may include, but are not limited to: a client installed in a terminal, an applet (as a subprogram of the client) that can be used without downloading and installing, a web (World Wide Web) application program opened through a browser, and the like. For another example, when being classified according to function types of the application programs, the application programs may include, but are not limited to: an instant messaging (IM) application program, a content interaction application program, and the like. The IM application program refers to an Internet-based instant message exchange and social interaction application program. The IM application program may include, but is not limited to: a social application program including a communication function, a map application program including a social interaction function, a game application program, and the like. The content interaction application program refers to an application program that can implement content interaction, and may be, for example, an application program such as an online bank, a sharing platform, a personal space, or news.

The resource recommendation platform may alternatively be a plug-in (or function) that supports resource recommendations and that is included in the application program mentioned above. For example, if the application program is an IM application program in the form of a client, a resource distribution platform may be a resource distribution plug-in included in the IM application program. For example, when the resource data is a short video, the resource recommendation function provided by the IM application program is a short video recommendation function. In this way, the target object (for example, any object using the IM application program) can still perform functions such as resource browsing and publishing during social interaction using the IM application program, without the need to perform application jump (for example, jump from the IM application program to an independent resource recommendation application program).

Types of resource data distributed by the same resource recommendation platform are not limited to one type. For example, the resource types of resource data whose distribution is supported by the same resource recommendation platform may include both videos and documents. In addition, the resource type of the resource data distributed by the resource recommendation platform, and a type of application program of the foregoing types of application programs which the resource recommendation platform is specifically, or an application program which provides a resource recommendation function are not limited in the embodiments of this application. For ease of description, the following embodiments are described by using an example in which a resource distributed by the resource recommendation platform (or the resource recommendation system) is a short video.

Based on the foregoing related descriptions of the transfer learning and the resource recommendation, the embodiments of this application provide a model training solution. The model training solution involves a cross-domain recommendation. The cross-domain recommendation aims to combine data of a plurality of domains, introduce information of another domain (for example, at least one source domain) to assist, and capture, by analyzing interaction data of an object in the another domain, a preference or an interest of the object in a specific aspect, so that better recommendations can be made on a target domain and even a plurality of domains.

In a specific implementation, the model training solution provided in the embodiments of this application is a training solution for an interest alignment model. The interest alignment model may be referred to as a cross-domain recommendation model or the like. Specifically, interest alignment learning is performed on the interest alignment model using an interest relationship between objects, that is, a relationship between different objects interested in resource data (for example, resource data of interest to an object A is similar to that to an object B), including a cross-domain object interest relationship and an intra-domain object interest relationship, thereby achieving an objective of guiding interest learning in the target domain. An approximate training procedure of the model training solution may include: obtaining a data set for performing model training, the data set including first domain data of a first domain and second domain data of a second domain; then, calling the interest alignment model to perform feature extraction on the first domain data to obtain a first domain feature representation (namely, an embedding vector), and calling the interest alignment model to perform feature extraction on the second domain to obtain a second domain representation; performing interest alignment processing (or referred to as interest similarity degree alignment processing) including cross-domain alignment processing and inter-domain alignment processing between the first domain and the second domain based on the first domain feature representation and the second domain feature representation; and finally, training the interest alignment model according to a direction of reducing a first loss of the feature extraction process and a loss of the interest alignment processing process, to obtain a trained interest alignment model.

The trained interest alignment model may be obtained based on the foregoing model training process. The interest alignment model is configured for making a resource data recommendation to a target object (for example, any object to which resource data is to be distributed) in the second domain. Specifically, after the trained interest alignment model is obtained, the embodiments of this disclosure further support calling the trained interest alignment model to recommend resource data to the target object logged in to the resource recommendation platform. Specifically, the interest alignment model is used to generate an accurate object feature representation (namely, an embedding vector that can represent an attribute or a feature of the target object) for the target object to which the resource data is to be distributed. Then, part of the resource data satisfying interests or hobbies of the target object is selected from a database of the resource recommendation platform according to the object feature representation, to subsequently select resource data from the part of the resource data and recommend the selected resource data to the target object.

It can be learned that, in the embodiments of this disclosure, with reference to the transfer learning, rich knowledge and information in the first domain are used to enrich data in the second domain, to increase available information, alleviate a problem of a sparse sample quantity in the second domain, and ensure model performance of the trained interest alignment model. Even when the trained interest alignment model is applied to the second domain with less interaction data, a more accurate feature representation can still be produced for the object, so that the resource data recommended to the object based on the accurate feature representation satisfies the personalized needs of the object, and an accurate recommendation of resources is implemented.

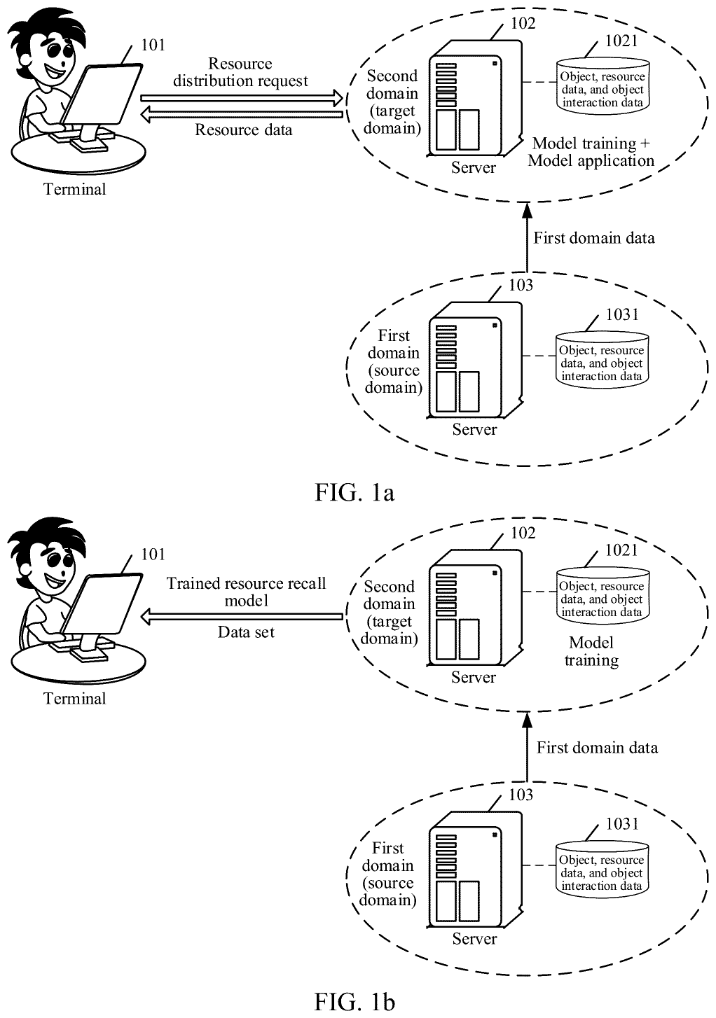

For case of understanding of the model training solution provided in the embodiments of this disclosure, the following briefly describes a resource recommendation scenario involved in the embodiments of this disclosure with reference to a resource recommendation system shown in FIG. 1a. As shown in FIG. 1a, the resource recommendation system includes a terminal 101, a server 102, and a server 103. Quantities and names of terminals 101, servers 102, and servers 103 are not limited in the embodiments of this disclosure.

The terminal 101 may be a terminal device used by a resource recipient that is registered in a resource recommendation platform and to which resource data is to be distributed. The terminal device may include, but is not limited to: a device such as a smartphone (for example, a smartphone deployed with an Android system or a smartphone deployed with an internetworking operating system (IOS)), a tablet computer, a portable personal computer, a mobile Internet device (MID), a vehicle-mounted device, a head-mounted device, and the like. Types of terminal devices are not limited in the embodiments of this disclosure. Explanation is given hereby. The resource recommendation platform, specifically an application program carrying the resource recommendation platform, is deployed in the terminal device. The resource recommendation platform may be a recommendation platform in the second domain. In this way, the resource recipient can perform operations such as receiving the resource data in the second domain through the resource recommendation platform deployed in the terminal device.

The server 102 is a server corresponding to the terminal 101, specifically, a backend server of the resource recommendation platform deployed in the terminal 101, and is configured to interact with the terminal 101 to provide computing and application service support for the resource recommendation platform in the terminal 101. The server 103 may be a backend server corresponding to the resource recommendation platform for the first domain. The server 103 may perform data communication with the server 102 to provide first domain data for model training, and the like. The servers (such as the server 102 and the server 103) may be independent physical servers, or may be a server cluster or a distributed system formed by a plurality of physical servers, or may be cloud servers that provide basic cloud computing services such as a cloud service, a cloud database, cloud computing, a cloud function, cloud storage, a network service, cloud communication, a middleware service, a domain name service, a security service, a Content Delivery Network (CDN), big data, and an AI platform. The terminal 101 and the server may be directly or indirectly connected to each other in a wired or wireless communication manner. This is not limited in this application.

The server 102 further includes a database 1021. The database 1021 may be configured to store all resource data included in the resource recommendation platform of the second domain (that is, the target domain), objects, object (user-item) interaction data between the objects and the resource data, and the like. For example, in a video recommendation scenario, a video platform includes an object 1 and an object 2, the object 1 clicks on a video 1 and a video 2, and the object 2 clicks on the video 1 and a video 3. In this case, interaction data between the objects and the videos, such as object 1-video 1 (indicating that the object 1 triggers the video 1), object 1-video 2 (indicating that the object 1 triggers the video 2), object 2-video 1 (indicating that the object 2 triggers the video 1), and object 2-video 2 (indicating that the object 2 triggers the video 2) may be stored in the database. Similarly, the server 103 also includes a database 1031. The database 1031 may be configured to store all resource data included in the resource recommendation platform of the first domain (that is, the source domain), objects, and object interaction data between the objects and the resource data. For the specific content of the object interaction data, reference may be made to the related description of the second field, and details are not described herein again.

There are two long-term problems in the resource recommendation system: a data sparsity problem and a cold start problem. The data sparsity problem means that there is little object interaction data between the object and the resource data. As a result, it is difficult to well capture an interest of the object or a characteristic of the resource data based on a small amount of object interaction data. The cold start problem refers to a case that there is no object interaction data for an object newly registered with or logged in to the resource recommendation platform, or for resource data newly uploaded or posted to the resource recommendation platform. Due to data sparsity and scarcity of object interaction data in cold start, conventional recommendation algorithms that make recommendations based on object interaction data between objects and resource data are difficult to make appropriate recommendations in both cases. Different from this, the embodiments of this disclosure perform model training of the interest alignment model with reference to the transfer learning, that is, support using rich knowledge and information in the first domain to improve performance in the second domain and reduce a quantity of training samples required in the second domain, so that a problem of a small quantity of training samples caused by data sparsity and cold start in a recommendation scenario is well resolved. In this way, even when the interest alignment model obtained through the cross-domain training is applied to the second domain, an accurate feature representation can still be generated for an object without object interaction data or with sparse object interaction data, to recommend resource data (that is, resources included in the target domain) to the user based on the accurate feature representation. It can be learned that, the model training solution provided in the embodiments of this disclosure may be applied to a resource recommendation scenario, and has a better effect during model training particularly when being applied to a data sparsity scenario or a cold start scenario.

The model training solution provided in the embodiments of this disclosure may be performed by either or both of the terminal 101 and the server 102 in the architecture shown in FIG. 1a. In other words, the electronic device as the execution body in the embodiments of this disclosure may be at least one of the terminal 101 or the server 102. A training process of the foregoing interest alignment model is performed by the server 102. As shown in FIG. 1a, the trained interest alignment model may be directly deployed in the server 102, so that the server 102 calls the trained interest alignment model to implement a resource recommendation each time resources are distributed. Under this implementation, the electronic device as the execution body configured to perform the solutions provided in the embodiments of this disclosure is the server 102. The trained interest alignment model may alternatively be deployed in the terminal 101. As shown in FIG. 1b, after the interest alignment model is trained in the server 102, the trained interest alignment model is transmitted to the terminal 101, and the trained interest alignment model is deployed in the terminal 101. In this case, the electronic device as the execution body of the model training solution provided in the embodiments of this disclosure includes the terminal 101 and the server 102. If the interest alignment model is trained by the terminal 101, the trained interest alignment model may be directly deployed in the terminal 101. In this case, the electronic device as the execution body of the model training solution provided in the embodiments of this disclosure includes the terminal 101.

FIG. 1a and FIG. 1b are each a schematic diagram of an architecture of merely an example of a resource recommendation system according to an embodiment of this disclosure. In actual application, the architecture may adaptively change. For example, there may be a plurality of first domains provided in the embodiments of this disclosure. In other words, the embodiments of this disclosure can adapt to a plurality of source domains. In this way, information about more domains can be used to assist in learning of the target domain. In this case, a quantity of servers included in the architecture correspondingly increases. In addition, when the embodiments of this disclosure are applied to specific products or technologies, for example, when a resource recommendation is performed on resource data, attribute information (such as age, gender, name, or other information) of the target object is inevitably to be obtained. In this case, permission or consent of the target object needs to be obtained, and collection, use, and processing of relevant data need to comply with relevant laws, regulations, and standards of relevant countries and regions.

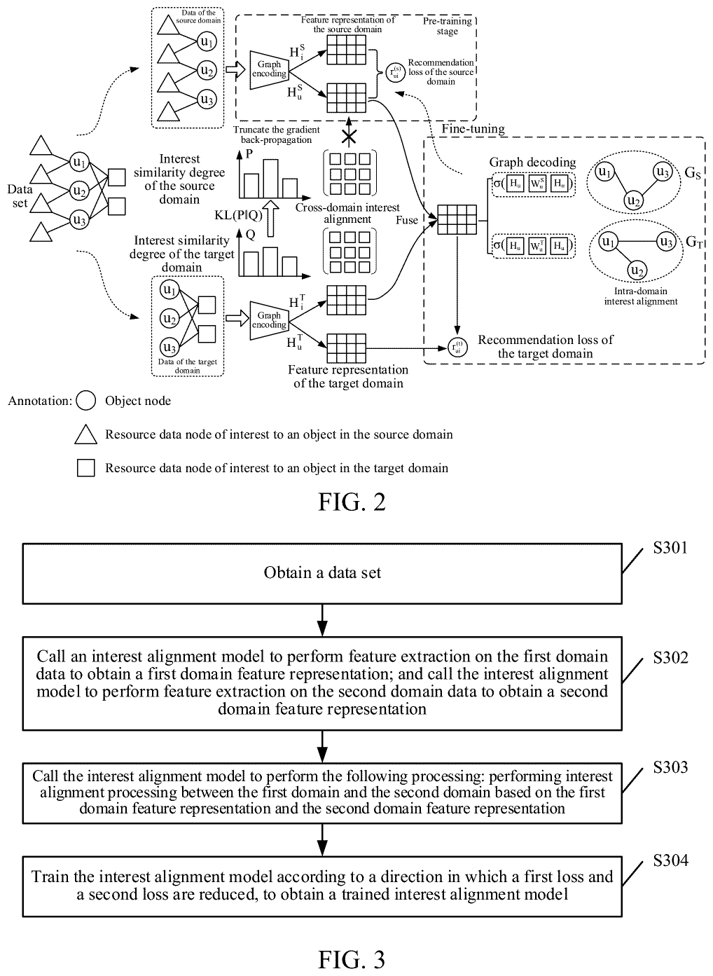

Based on the model training solutions described above, it can be learned that the model training solutions provided in the embodiments of this disclosure mainly involve two aspects. In one aspect, a trained interest alignment model is obtained through model training. In the other aspect, a resource recommendation is performed by using the trained interest alignment model (that is, model application). To facilitate better understanding of method operations of a model training method provided subsequently in the embodiments of this disclosure, a schematic diagram of a model structure of an interest alignment model according to an embodiment of this disclosure is first given below with reference to FIG. 2. As shown in FIG. 2, the interest alignment model (or referred to as an object interest alignment model) provided in this embodiment of this disclosure may include a single-domain feature extraction module, a cross-domain alignment module, and an intra-domain alignment module.

The single-domain feature extraction module is configured to perform feature extraction on domain data in a single domain (for example, a specific domain) to obtain a domain feature representation of the single domain. As a quantity of domains in actual application differs, a quantity of single-domain feature extraction modules differs. For example, when one source domain (that is, first domain) and one target domain (that is, second domain) are included, the single-domain feature extraction module may include a first feature extraction module and a second feature extraction module. The first feature extraction module is configured to perform feature extraction on first domain data in the first domain to obtain a first domain feature representation; and the second feature extraction module is configured to perform feature extraction on second domain data in the second domain to obtain a second domain feature representation. The first feature extraction module corresponding to the first domain is obtained through pre-training. To be specific, in the pre-training stage, the first feature extraction module may be pre-trained to learn interests or hobbies of an object in the first domain. In this way, with the assistance of object interaction data of the first domain, the first feature extraction module, and feature representations of the object and resource data in the first domain may be optimized. When task learning is performed on the second domain, the pre-trained first feature extraction module is directly transferred to a learning task of the second domain. In other words, in this embodiment of this disclosure, the trained first feature extraction module is used as an initial point based on an idea of the transfer learning, and is reused in a process of developing a model for task learning of the second domain. In this way, the feature representation of the object generated based on the trained first feature extraction module may be used as a true label for the supervised learning to optimize the interest alignment model.

The cross-domain alignment module or referred to as a cross-domain interest alignment module, an inter-domain alignment module, or the like may be configured to perform interest alignment processing between an interest relationship (which may be referred to as a second attention similarity degree in this embodiment of this disclosure) between two objects in the second domain and an interest relationship (which may be referred to as a first attention similarity degree in this embodiment of this disclosure) between two corresponding objects in the first domain. In other words, in this embodiment of this disclosure, the inter-domain alignment module is designed to align the interest similarity between the objects in the second domain with the interest similarity between the objects in the first domain. In this way, the interest relationship between the objects in the first domain can be transferred to the second domain, thereby guiding the interest learning process of the second domain.

The intra-domain alignment module or referred to as an intra-domain interest alignment module may be configured to perform interest alignment processing between an object graph (including only images of objects) of the first domain and an object resource graph (including objects and resource data of interest to the objects) of the first domain, and perform interest alignment processing between an object graph of the second domain and an object resource graph of the second domain. In other words, in this embodiment of this disclosure, the intra-domain alignment module is designed to align an interest relationship of objects in a single domain, so that feature representations between objects with similar interests or hobbies in the single domain are closer. Therefore, when the interest alignment model is subsequently used, even if an object has no object interaction data or little object interaction data, an interest relationship between the object and another object having object interaction data can still be analyzed, to generate an accurate feature representation for the object based on an accurate feature representation of the another object.

In the model training solution provided in the embodiments of this disclosure, the interest alignment of the objects may include inter-domain interest alignment and intra-domain interest alignment. The inter-domain interest alignment is to align an interest similarity between two objects in the second domain with an interest similarity between the two objects in the first domain, and the intra-domain interest alignment is to align a predicted interest similarity between two objects with a true interest similarity between the two objects for a single domain. In actual application, the model training solution may include at least one of the two types of interest alignment given above. For case of description, the following embodiments are described by using an example in which the model training solution includes both the inter-domain interest alignment and the intra-domain interest alignment. Explanation is given hereby.

Based on the foregoing simple descriptions of the model structure of the interest alignment model with reference to FIG. 2, the following describes, with reference to the accompanying drawings, method operations of a more detailed model training method provided in the embodiments of this disclosure, and specifically describes a model training process and a model application process included in the model training method.

For a specific training process of training the interest alignment model according to the learning method of transfer learning, reference may be made to FIG. 3. FIG. 3 is a schematic flowchart of a model training method according to an example embodiment of this disclosure. The model training method may be performed by the foregoing electronic device. The method may include, but is not limited to, operations S301 to S304.

S301: Obtain a data set.

The data set is a sample set configured for training an interest alignment model. The data set may include first domain data of a first domain and second domain data of a second domain. The first domain may be a source domain including rich object interaction data, and the second domain is a to-be-learned target domain including little object interaction data. The first domain data of the first domain includes at least one object and first resource data of interest to each object in the first domain. The at least one object included in the first domain data is an object registered in or temporarily logged in to a resource recommendation platform corresponding to the first domain. The first resource data of interest to each of the at least one object in the first domain refers to partial resource data triggered by the object in the first domain. That the object triggers the first resource data described herein may include, but is not limited to: The object clicks on the first resource data, the object comments on (or forwards, collects, or gives a like to) the first resource data, and the object browses the first resource data for a browsing duration exceeding a duration threshold (for example, 10 seconds). Similarly, the second domain data of the second domain includes at least one object and second resource data of interest to each object in the second domain. The at least one object included in the second domain data is the same as the at least one object included in the first domain data mentioned above. In other words, overlapping data included in the first domain data and the second domain data is an object. In this way, even if the object interaction data of the object in the second domain is little, the rich object interaction data of the object in the first domain can still be used to guide the supervised learning in the second domain. For related content of the second resource data of interest to the object, reference may be made to the foregoing related descriptions regarding the first domain, and details are not described herein again.

The first domain data and the second domain data in the data set may exist in the form of a graph. The graph herein refers to network structure data composed of nodes and connection edges (or edges for short). The nodes in the graph may include the object, the first resource data, and the second resource data. A connection edge refers to a connection line between nodes, specifically, a connection line obtained by connecting an object node and a resource data node in which the object is of interest. Considering that the data involved in the data set includes such types as the object, the first resource data, and the second resource data, that is, the sum of node types and connection edge types is greater than 2, the graph constructed in this embodiment of this disclosure is a heterogeneous graph (or referred to as a heterogeneous network). Types of nodes and connection edges in the heterogeneous graph are not single but diversified.

For a schematic diagram in which the first domain data and the second domain data in the data set exist in the form of a heterogeneous graph, reference may be made to FIG. 2 given above. As shown in FIG. 2, the data set includes such three types of nodes as triangles, circles, and squares. A triangle represents a first resource data node in the first domain data, a circle represents an object node (for example, a node u1 corresponds to an object 1, a node u2corresponds to an object 2, and a node u3 corresponds to an object 3), and a square represents a second resource data node in the second domain data. A connection edge between a triangle node and a circle node indicates that an object corresponding to the circle node is of interest in first resource data corresponding to the triangle node connected by the connection edge. Similarly, a connection edge between a circle node and a square node indicates that an object corresponding to the circle node is of interest in second resource data corresponding to the square node connected by the connection edge.

To test an on-line effect of deploying a trained interest alignment model (that is, a cross-domain recommendation algorithm based on object interest alignment) (if a resource recommendation is intended to be made to an object in a cold start scenario, a recommendation effect of a cold start object is mainly observed during on-line testing), the embodiments of this disclosure support deploying the interest alignment model in a recall module of the resource recommendation platform. In this way, streaming updated object interaction data may be used as sample data to perform model training on the interest alignment model. In other words, in the embodiments of this disclosure, the streaming updated object interaction data in the resource recommendation platform is obtained as the data set for model training. In other words, the first domain data and the second domain data included in the data set are dynamically updated. Therefore, when the interest alignment model is trained according to the dynamically updated data set, the interest alignment model also dynamically changes. Therefore, the interest alignment model is enabled to dynamically adapt to changes in interests or hobbies of the object in the resource recommendation platform, thereby ensuring that the interest alignment model can always keep generating an accurate feature representation for the object in the resource recommendation platform and can satisfy dynamically changing personalized resource requirements of the object.

S302: Call an interest alignment model to perform feature extraction on the first domain data to obtain a first domain feature representation; and call the interest alignment model to perform feature extraction on the second domain data to obtain a second domain feature representation.

After the data set for training the interest alignment model is obtained, the embodiments of this disclosure support using the data set to perform single-domain feature representation. In other words, feature extraction (or referred to as feature representation) is performed on the first domain data and the second domain data respectively based on the data set, to obtain a first domain feature representation of the first domain and a second domain feature representation of the second domain.

A domain feature representation of any domain may be implemented by using an embedding vector. Therefore, the feature representation may also be referred to as an embedding representation. The embedding vector is a low-dimensional vector used to represent a feature or attribute of an object. A distance between embedding vectors of any two objects may represent a similarity degree between the any two objects. For example, if a distance between embedding vectors of two objects is less than a distance threshold, the two objects are relatively similar (for example, features or attributes are similar). If the distance between the embedding vectors of the two objects is greater than or equal to the distance threshold, a similarity degree between the two objects is relatively low. In the embodiments of this disclosure, a domain feature of any domain may include a feature representation of an object and a feature representation of resource data in the any domain. For example, the first domain feature of the first domain may include a feature representation of an object and a feature representation of first resource data. The feature representation of the object may be configured for representing a feature or attribute of the object (for example, interests or hobbies of the object in the first domain). The feature representation of the first resource data may be configured for representing a feature or attribute of the resource data (for example, a resource type of the resource data). A distance between feature representations of any two objects may be configured for representing an interest similarity between the any two objects.

Processes of feature extraction on single-domain domain data in the embodiments of this disclosure are similar. That is to say, the process of feature extraction on the first domain data to obtain the first domain feature representation is similar to the process of feature extraction on the second domain data to obtain the second domain feature representation. The following gives an approximate feature extraction process of the feature representation of the first domain and the feature representation of the second domain respectively, and a specific implementation process of performing feature extraction on the second domain data is given in detail by using the feature representation of the second domain as an example. The process of performing the feature representation on the first domain data to obtain the first domain feature representation may include: constructing an object resource graph of the first domain based on the first domain data, where the object resource graph of the first domain is a graph in which each object and each first resource data are nodes and a first interest relationship between the object and the first resource data is a connection edge; and that there is the first interest relationship between the object and the first resource data may mean that the object generates interaction data for the first resource data; calling the interest alignment model to perform graph encoding processing on the object resource graph of the first domain to obtain a first object feature representation of each object and a first resource feature representation of each first resource data; and forming the first domain feature representation by using the first object feature representation of each object and the first resource feature representation of each first resource data.

The process of performing the feature representation on the second domain data to obtain the second domain feature representation may include, but is not limited to operations (1) and (2):

(1) Construct an object resource graph of the second domain based on the second domain data, the object resource graph of the second domain being a graph in which each object and each second resource data are nodes and a second interest relationship between the object and the second resource data is a connection edge. The object resource graph of the second domain herein may refer to a bipartite graph (or referred to as a bigraph, which is a special heterogeneous graph) of the second domain. As described above, the data set may be presented in the form of a heterogeneous graph. For any node in the heterogeneous graph, a node having a connection edge to the any node may be referred to as a neighbor node of the any node. A neighbor node of a u1 node shown in FIG. 2 includes two pieces of first resource data and two pieces of second resource data having connection edges to the u1 node. In this case, a process of constructing an object resource graph of the second domain based on the second domain data herein may include: Neighbor sampling is performed on the heterogeneous graph of the data set to obtain the object resource graph of the first domain. The neighbor sampling may include a process of selecting some neighbor nodes from all neighbor nodes (in this case, first resource data nodes and second resource data nodes) of object nodes in the heterogeneous graph of the data set. In this case, the embodiments of this disclosure support neighbor sampling of each object node in the heterogeneous graph of the data set, to construct the object resource graph of the second domain based on each object node and each sampled second resource data.

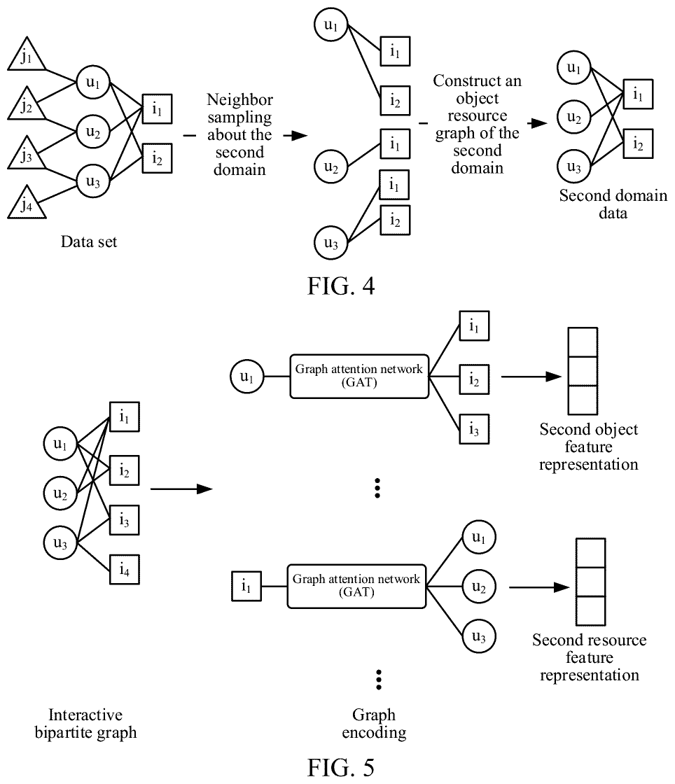

As shown in FIG. 4, the data set includes an object node u1, an object node u2, and an object node u3. In addition, neighbor nodes of the object node u1 include a first resource data node j1, a first resource data node j2, a second resource data node i1, and a second resource data node i2, neighbor nodes of the object node u2 include the first resource data node j2, a first resource data node j3, and the second resource data node i1, and neighbor nodes of the object node u3 include the first resource data node j3, a first resource data node j4, the second resource data node i1, and the second resource data node i2. Then, after neighbor sampling is performed on the heterogeneous graph of the data set based on the second domain data, it can be learned through the sampling that neighbor nodes of the object node u1 are the second resource data node i1 and the second resource data node i2, neighbor nodes of the object node u2 are the second resource data node i1, and neighbor nodes of the object node u3 are the second resource data node i1 and the second resource data node i2. In this case, the object resource graph of the second domain may be constructed based on the object nodes and the second resource data in which each object node is of interest. A connection edge between an object node and a second resource data node in the object resource graph indicates that an object corresponding to the object node has an interactive behavior with second resource data corresponding to the second resource data node.

(2) Call the interest alignment model to perform graph encoding processing on the object resource graph of the second domain to obtain a second object feature representation of each object and a second resource feature representation of each second resource data.

Specifically, the embodiments of this disclosure support using a graph encoder to capture rich semantic information of an object resource graph, and adding a node-level attention mechanism to distinguish importance of each neighbor node. For a schematic diagram of an example graph encoding learning architecture (or an architecture of a second feature extraction module), reference may be made to FIG. 5. As shown in FIG. 5, the second feature extraction module includes a GAT. Through an attention mechanism included in the GAT, feature representation may be performed on each attention node in an inputted object resource graph of a second domain. The attention node herein may refer to any node in the object resource graph, such as any object node or any second resource data node.

After the object resource graph of the second domain is inputted into the second feature extraction module, the GAT may be called to use object nodes and second resource data nodes as attention nodes respectively, to distinguish importance of neighbor nodes of the attention nodes, thereby obtaining a feature representation of each attention node. When the attention node is an object node, a neighbor node of the object node refers to a second resource data node having a connection edge to the object node. The distinguishing the importance of each neighbor node may refer to determining a liking degree (or referred to as an interest or hobby degree) of an object corresponding to the object node for each second resource data. When the attention node is a second resource data node, a neighbor node refers to an object node having a connection edge to the second resource data node. The distinguishing the importance of each neighbor node may refer to determining a liking degree of an object corresponding to each object node for second resource data corresponding to the second resource data node.

Specific implementation processes of calling the GAT to determine the feature representation of each attention node are similar. In this embodiment of this disclosure, using an example in which any one of the at least one object included in the second domain data is represented as a training object, a specific implementation process of calling the graph attention mechanism to distinguish importance of each neighbor node of the training object to obtain a second object feature representation corresponding to the training object is given. The implementation process may include, but is not limited to, operations s11 to s13.

s11: Obtain an initial feature representation of the training object in the second domain and an initial feature representation of each second resource data of interest to the training object in the second domain. The initial feature representation of the training object is determined based on attribute information (such as basic object information (such as age, gender, a selected category label, or other information)) of the training object. The initial feature representation of the second resource data is determined based on attribute information (such as uploading time of the second resource data and a category label selected during uploading) of the second resource data.

s12: Call the interest alignment model to calculate a correlation degree between the training object and each second resource data of interest to the training object according to the initial feature representation of the training object and the initial feature representation of each second resource data of interest to the training object. The correlation degree between the training object and any second resource data of interest to the training object may be configured for representing: a liking degree of the training object for the any second resource data. The correlation degree may be in the form of a probability. For example, the correlation degree is 20%, indicating that the training object has a low liking degree for the second training resource data. A formula for calculating a correlation degree between a training object and any second resource data of interest to the training object is as follows:

$${a}_{ui} = \frac{exp ( LeakyReLU ( {a}^{T} [ {Wh}_{u} ‖ {Wh}_{i} ] ) )}{{\sum }_{k ∈ {N}_{u}} exp ( LeakyReLU ( {a}^{T} [ {Wh}_{u} ‖ {Wh}_{k} ] ) )} \qquad ( 1 )$$

where aᵤᵢ represents a correlation degree (that is, a correlation) between an object node u and second resource data node i, hᵤ represents an initial feature representation of a training object corresponding to the object node u, and hᵢ represents an initial feature representation of second resource data corresponding to the second resource data node i; Nᵤ represents a neighbor set of the object node u, the neighbor set includes all second resource data nodes having a connection edge with the object node u, and k represents any second resource data node in the neighbor set of the object node u, that is, the second resource data node i is any second resource data node in the neighbor set of the object node u; and the LeakReLU function is an activation function.

Based on the foregoing Formula (1), it can be learned that the embodiments of this disclosure support calculating a correlation between a training object and second resource data of each neighbor of the training object. For example, a similarity aᵤᵢ between an object node u corresponding to the training object and a second resource data node i corresponding to the second resource data is calculated. Specifically, a correlation between the object node u and the second resource data node i is used as the numerator, and a sum of correlations between the object node u and all neighboring second resource data nodes Nᵤ are used as the denominator. In this way, the correlation with respect to the second resource data i is used as the numerator, and the sum of the correlations of all the neighbor nodes is used as the denominator, which is conducive to quickly determining the proportion of the second resource data corresponding to the second resource data node i in all the second resource data of interest to the training object, thereby determining the importance of the second resource data to the training object.

s13: Obtain a first object feature representation of the training object based on the correlation degree between the training object and each second resource data of interest to the training object, the initial feature representation of the training object in the second domain, and the initial feature representation of each second resource data of interest to the training object. In other words, after the correlation degree between the training object and second resource data of each neighbor is obtained based on operation s12, the liking degree of the training object for each second resource data can be approximately determined. In order to obtain the first object feature representation of the training object, that is, the overall interest or preference of the training object, the first object feature representation of the training object needs to be further expressed based on the correlation degree between the training object and the second resource data of each neighbor, and the initial feature representations of the second resource data and the training object, thereby obtaining the overall interest or preference of the training object (for example, preference for a specific type of resource data). A calculation formula for determining a second object feature representation of a training object is as follows:

\acute{h}ᵤ=σ(Σ_{i∈N}_{ᵤ} aᵤᵢhᵢ+hᵤ) (2)

where \acute{h}ᵤ represents a first object feature representation of the training object, and σ(*) represents an activation function.

Based on the above, through the specific implementation process shown in operations s11 to s13 described above, the GAT may be called to capture the rich semantic information in the object resource graph, thereby determining a second object feature representation of an object corresponding to each object node, to describe an interest or a preference of the object corresponding to the object node.

A specific implementation process of calling the GAT to obtain the second resource feature representation of the second resource data corresponding to each second resource data node in the object resource graph of the second domain is similar to the specific implementation process of obtaining the first object feature representation described above. The only difference is that when the second resource feature representation of the second resource data is calculated, the neighbor set is all object nodes adjacent to the second resource data node of the second resource data in the object resource graph. A specific implementation process of determining the second resource feature representation of the second resource data is not described in detail herein. Similarly, a specific implementation process of performing feature extraction on the first domain data based on the first feature extraction module (specifically the GAT included in the first feature extraction module) in the interest alignment model to obtain the first domain feature representation (including the first object feature representation and the first resource feature representation) is similar to the specific implementation process of obtaining the first object feature representation given above, and details are not described herein again.

The first feature extraction module corresponding to the first domain is pre-trained, that is, the first feature extraction module has been optimized by using the rich object interaction data in the first domain in the pre-training stage. Therefore, in a process of training the interest alignment model, there is no need to optimize the first feature extraction module according to the predicted first domain feature representation of the first domain data. However, object interaction data in the second domain is scarce. Therefore, the trained first feature extraction module is migrated to the model training process of the interest alignment model, to help better optimize the second feature extraction module.

Based on this, after the feature representations of the object nodes and the second resource data nodes in the second domain are obtained based on the foregoing operations, the liking degrees of the objects for the second resource data need to be further learned. Specifically, the liking degree of each object for the second resource data of interest is predicted. In addition, the interest alignment model is trained based on a difference between the predicted liking degree of the object for the second resource data of interest and a true liking degree of the corresponding object for the corresponding second resource data of interest. Specifically, the second feature extraction module is optimized to improve the feature extraction performance of the second feature extraction module, that is, the optimized second feature extraction module can predict a more accurate object feature representation for the object.

First, the embodiments of this disclosure support fusing a first object feature representation of each object in the first domain and a second object feature representation of each object in the second domain to obtain a fused feature representation of each object. A feature of interest of the object in the first domain and a feature of interest of the object in the second domain are combined together to form a more complementary representation of interest of the object. For example, the first object feature representation of the object node u in the first domain is h\acute{1}ᵤ, and the second object feature representation of the object node u in the second domain is h\acute{2}ᵤ. In this case, the first object feature representation h\acute{1}ᵤ and the second object feature representation h\acute{2}ᵤ of the object node u are added, and a fused feature representation of the object node u can be obtained (in this embodiment of this disclosure, \acute{h}′ᵤ represents the fused feature representation of the object node u).

Then, a splicing operation is performed on the fused feature representation of each object and the second resource feature representation of the second resource data of interest to the corresponding object to obtain a predicted attention degree (that is, a predicted liking degree) of each object to the corresponding second resource data of interest. A calculation formula of obtaining the predicted attention degree of each object in the corresponding second resource data of interest is as follows:

\hat{r}ᵤᵢ=sigmoid(f(\acute{h}′ᵤ⊕\acute{h}′ᵢ)) (3)

where \acute{h}′ᵤ represents a fused feature representation of the object node u, h′ᵢ represents a second resource feature representation of second resource data corresponding to a second resource data node i in which the object node u is of interest, ⊕ represents a splicing operation, sigmoid (*) represents an activation function, and \hat{r}ᵤᵢ represents a predicted attention degree of the object corresponding to the object node u in the second resource data corresponding to the second resource data node i.

Finally, the data set includes a true attention degree of each object in the corresponding second resource data of interest, so that a true attention degree of an object in the second resource data of interest can be obtained from the data set; and the first loss of the interest alignment model is constructed based on a difference between the true attention degree of each object to the corresponding second resource data of interest and the predicted attention degree, to subsequently train the interest alignment model based on the first loss. The embodiments of this disclosure support learning the interest or preference of the object for the second resource data of interest through a least square error. A formula for the least square error is as follows:

$${ℒ}_{rec} = \frac{1}{\vert R \vert} {\sum }_{( u , i ) ∈ R} {( {r}_{ui} - {\hat{r}}_{ui} )}^{2} \qquad ( 4 )$$

where R represents an object-second resource data interaction matrix; and rᵤᵢ represents a true attention degree of the object to the second resource data, where the true attention degree is obtained by scoring the second resource data by the object through the resource recommendation platform.

As described above, the first feature extraction module corresponding to the first domain is pre-trained. When the first feature extraction module is pre-trained in the pre-training stage, a process of determining a predicted attention degree of an object in the first resource data and a loss is similar to the model training process in the second domain described above, and details are not described herein again. For case of distinction, in this embodiment of this disclosure, the first loss of the second domain is represented as L_{rec}^{T}. Explanation is given hereby.

S303: Call the interest alignment model to perform the following processing: performing interest alignment processing between the first domain and the second domain based on the first domain feature representation and the second domain feature representation.

It can be learned from the foregoing descriptions that, this embodiment of this disclosure supports interest similarity degree alignment of objects between domains and/or interest similarity degree alignment of objects in a domain. The following describes specific implementations of the two types of interest similarity degree alignment respectively.

(1) Inter-domain interest similarity degree alignment. In this embodiment of this disclosure, a cross-domain alignment module (or referred to as an inter-domain alignment module) is designed based on a phenomenon that there is a similarity degree between interests or hobbies of objects in domains, that is, a phenomenon that two objects with similar interests in the first domain also have similar interests in the second domain. Specifically, considering that the first domain has rich object interaction data of objects and the first feature extraction module of the first domain is pre-trained (that is, has good feature representation performance), inter-domain object interest similarity degree alignment is implemented using the cross-domain alignment module. The inter-domain object interest similarity degree alignment means that an interest similarity degree between two objects in the first domain is used as a true label, and object interest similarity degree alignment is performed between an interest similarity degree between the two objects in the second domain and the interest similarity degree in the first domain, thereby guiding learning of the interest similarity degree in the second domain. In other words, in this embodiment of this disclosure, the interest relationship between the objects is fully considered, and the object interest similarity degree of the first domain is migrated to the second domain, that is, the object interest similarity degree of the second domain is aligned with that of the first domain, namely, the source domain, thereby achieving the objective of guiding interest learning of the second domain.

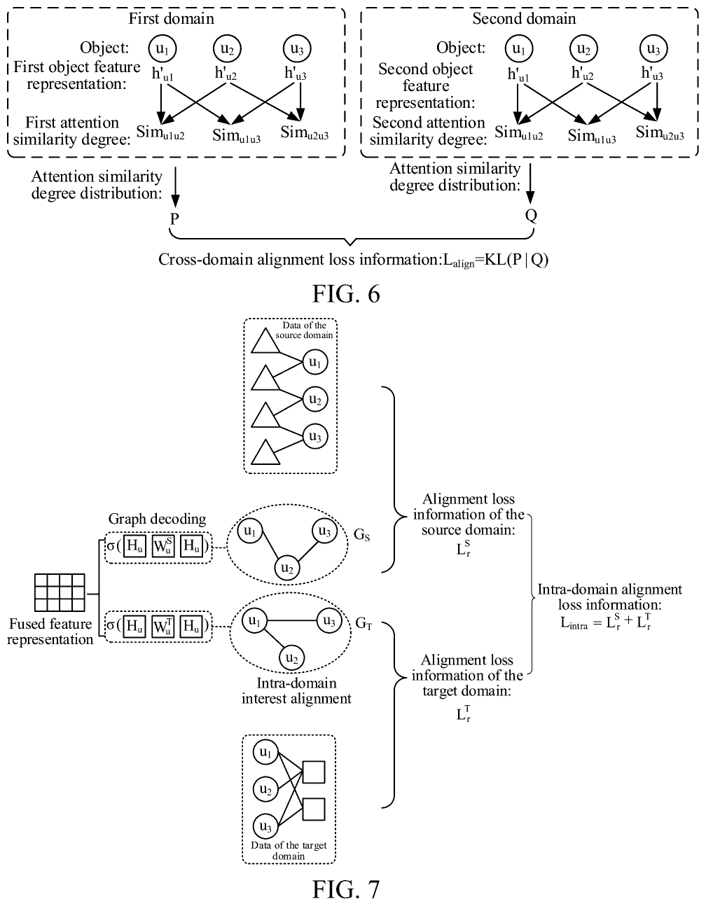

In a specific implementation, it can be learned based on the foregoing operations that, the first domain feature representation includes a first object feature representation of each object in the first domain data, and the second domain feature representation includes a second object feature representation of each object in the second domain data. A specific implementation process of calling the interest alignment model to perform interest alignment processing between the first domain and the second domain based on the first domain feature representation and the second domain feature representation is described below with reference to FIG. 6. In this case, the interest alignment processing includes cross-domain alignment processing. The cross-domain alignment processing includes but is not limited to operations s21 and s22.

s21: Call an interest alignment model (specifically, a cross-domain alignment module) to determine, based on the object feature representation of each object in a single domain, an attention similarity degree between each two objects in the single domain. Specifically, the interest alignment model is called to determine a first attention similarity degree between each two objects in the first domain based on the first object feature representation of each object, and the interest alignment model is called to determine a second attention similarity degree between each two objects in the second domain based on the second object feature representation of each object.

Considering different degrees of personalization of single domains, interest similarity degrees between objects in different domains differ greatly. For example, a specific single domain (such as a book domain or a movie domain) has a high personalization degree (that is, resource types of resource data in the single domain are widely different), and an object interest similarity degree is low (interests or hobbies of different objects in the same resource data). For another example, a specific single domain (such as a news domain) has a low personalization degree (that is, resource types of resource data in the single domain are slightly different), and an object interest similarity degree is high (that is, interests or hobbies of different objects in the same resource data). Therefore, a value of directly aligning an object interest similarity degree is affected by the property of the domain, and therefore cannot reflect an actual interest similarity degree between objects. Based on this, the embodiments of this disclosure support converting a distance between object feature representations of objects into a form of a probability to represent an interest similarity degree between the objects, thereby eliminating impact of domain properties.

Specific implementation processes of determining attention similarity degrees between each two objects in the first domain and the second domain are similar. A specific implementation process in which the interest alignment model is called to determine a first attention similarity degree between each two objects in the first domain based on the first object feature representation of each object is described below using an example in which a first attention similarity between each two objects in the first domain is determined.

First, a distance operation is performed on the first object feature representations of each two objects of a plurality of objects to obtain distance information between the first object feature representations of each two objects. The distance operation herein is a Euclidean distance operation. That is to say, the first object feature representation is in a vector form, and a vector distance between two vectors is calculated to obtain distance information between the two vectors. As shown in FIG. 6, it is assumed that at least one object includes an object u1, an object u2, an object u3, and a first object feature representation of the object u1 is h′ᵤ₁, a first object feature representation of the object u2 is h′ᵤ₂, a first object feature representation of the object u3 is h′ᵤ₃. Then, by performing a Euclidean distance operation on the object feature representations, it can be learned that a Euclidean distance between the first object feature representation h′ᵤ₁ of the object u1 and the first object feature representation h′ᵤ₂ of the object u2 is ∥h′ᵤ₁-h′ᵤ₂∥², a Euclidean distance between the first object feature representation h′ᵤ₁ of the object u1 and the first object feature representation h′ᵤ₃ of the object u3 is ∥h′ᵤ₁-h′ᵤ₃∥², and a Euclidean distance between the first object feature representation h′ᵤ₂ of the object u2 and the first object feature representation h′ᵤ₃ of the object u3 is ∥h′ᵤ₂-h′ᵤ₃∥².

Then, probability conversion is performed on the distance information between the first object feature representations of each two objects, to obtain the first attention similarity degree between each two objects. In other words, the Euclidean distance between the object feature representations of the objects is converted into a form of a probability to represent the attention similarity degree, which can avoid a problem that a true interest similarity degree between objects cannot be actually reflected due to an impact of a personalization degree of a domain on an alignment result. A formula for converting a Euclidean distance into a form of a probability to represent an interest similarity degree is as follows:

$${Sim}_{uiuj} = \frac{{( 1 + {‖ {h}_{ui}^{′} - {h}_{uj}^{′} ‖}^{2} / α )}^{\frac{- ( α + 1 )}{2}}}{{\sum }_{{uj}^{′}} {( 1 + {‖ {h}_{ui}^{′} - {h}_{{uj}^{′}}^{′} ‖}^{2} / α )}^{\frac{- ( α + 1 )}{2}}} \qquad ( 5 )$$

where h′ᵤᵢ represents a first object feature representation of an object ui, and h′ᵤⱼ represents a first object feature representation of an object uj; h′ᵤⱼ represents a first object feature representation of an object uj′, and the object uj′ is any one of the at least one object; and a represents a degree of freedom of distribution of a student t, and Simᵤᵢᵤⱼ represents an interest similarity degree between the user ui and the user uj.

s22: Based on the specific implementation process shown in operation s21 described above, a first attention similarity degree between each two objects in the first domain may be obtained, where the first attention similarity degree between any two objects is configured for representing a similarity degree between interests or hobbies of the any two objects in the first domain; and an attention similarity degree distribution P of the first domain may be determined based on the first attention similarity degree between each two objects in the first domain, where the attention similarity degree distribution P is a probability distribution composed of the first attention similarity degree between each two objects in the first domain. Similarly, based on the specific implementation process shown in operation s21 described above, a second attention similarity degree between each two objects in the second domain may be obtained, where the second attention similarity degree between any two objects is configured for representing a similarity degree between interests or hobbies of the any two objects in the second domain; and an attention similarity degree distribution Q of the second domain may be determined based on the second attention similarity degree between each two objects in the second domain, where the attention similarity degree distribution Q is a probability distribution composed of the second attention similarity between each two objects in the second domain.

A learning objective of the cross-domain alignment module in this embodiment of this disclosure is to minimize a difference (or a gap) between the attention similarity degree distribution P of the first domain and the attention similarity degree distribution Q of the second domain. This embodiment of this disclosure supports using a KL divergence as a loss function, constructing a cross-domain alignment loss of the interest alignment model based on the difference between the attention similarity degree distribution P of the first domain and the attention similarity degree distribution Q of the second domain, and using the cross-domain alignment loss as the second loss, thereby optimizing the interest alignment model by minimizing the cross-domain alignment loss. The KL divergence, or referred to as relative entropy, is an asymmetry measure of a difference between two probability distributions. In this embodiment of this disclosure, a calculation formula for obtaining the cross-domain alignment loss of the interest alignment model by using the KL divergence as the loss function is as follows:

$${L}_{inter} = KL ( P \vert Q ) = {\sum }_{ui} {\sum }_{uj} {p}_{uiuj} log \frac{{p}_{uiuj}}{{q}_{uiuj}} \qquad ( 6 )$$

where P represents the attention similarity degree distribution of the first domain, and pᵤᵢᵤⱼ represents a first attention similarity degree between the object ui and the object uj in the first domain; and Q represents the attention similarity degree distribution of the second domain, and qᵤᵢᵤⱼ represents a second attention similarity degree between the object ui and the object uj in the second domain.

Based on the above, based on the specific implementation processes shown in operations s21 and s22, a cross-domain alignment loss of the interest alignment model may be constructed.

(2) Intra-domain interest similarity degree alignment. The embodiments of this disclosure mainly use a graph decoding target to align an interest similarity degree between objects in a domain, to make feature representations of objects with similar interests or hobbies a single domain closer. Therefore, during model application, even if an object to which resource data is to be distributed is a cold start object, correctness of an object feature representation of the cold start object can still be ensured by analyzing an object feature representation of another object with similar interests or hobbies to the cold start object.

Considering that the domain data (in the form of a bipartite graph) inputted into the single-domain feature extraction module includes the interest similarity degree relationship between the objects in the single domain, if both the object node u1 and the object node u2 shown in FIG. 5 are connected to the second resource data i1, it is determined that the object corresponding to the object node u1 and the object corresponding to the object node u2 have similar interests or hobbies. In order to make feature representations of objects with similar interests or hobbies in a single domain closer, the embodiments of this disclosure support intra-domain object interest similarity degree alignment. The intra-domain object interest similarity degree alignment means that The input information (single-domain domain data) of the single-domain feature extraction module is used as the true label. Specifically, an interest similarity degree between two objects in the domain data inputted into the single-domain feature extraction module is used as the true label. A predicted interest similarity degree between the two objects in the single domain is aligned to the interest similarity degree, that is, interests of the objects in the domain are aligned, and object feature representations of the objects with similar interests or hobbies in the domain are closer. Based on this, in this embodiment of this disclosure, it is desirable to be able to reconstruct an interest relationship graph between objects based on fused feature representations of the objects. The interest relationship graph includes an interest relationship graph between the objects in the first domain and an interest relationship graph between the objects in the second domain respectively. The interest relationship graph is an object-object graph including only object nodes, so that intra-domain alignment learning can be performed based on the reconstructed object-object graph and the object resource graph inputted into the model.

A specific implementation process of calling the interest alignment model to perform interest alignment processing in each of the first domain and the second domain based on the first domain feature representation and the second domain feature representation is described below with reference to FIG. 7. In this case, the interest alignment processing includes intra-domain alignment processing, and the intra-domain alignment processing includes, but is not limited to, operations s31 to s33.

s31: Obtain a fused feature representation of each object, an object resource graph of the first domain, and an object resource graph of the second domain. A fused feature representation of any object is obtained by fusing a first object feature representation of the any object in the first domain and a second object feature representation of the any object in the second domain. By fusing the first object feature representation and the second object feature representation of the object, a complementary feature representation of the object may be formed, thereby alleviating a problem caused by little object interaction data in the second domain. The object resource graph of the first domain and the object resource graph of the second domain are input information of the interest alignment model. For related content of the object resource graph, reference may be made to the foregoing related descriptions. Details are not described herein again.

s32: Call the interest alignment model (specifically, an intra-domain alignment module included in the interest alignment model) to perform graph decoding processing regarding the first domain and graph decoding processing regarding the second domain on the fused feature representation of each object, to obtain an object graph of the first domain and an object graph of the second domain. The object graph herein is the object-object graph described above, and the object graph is a graph in which each object is used as a node and a second interest relationship between objects is used as a connection edge; and the second interest relationship between the objects may mean that the two objects generate interaction data for the same resource data.

As an example, to reconstruct the object graph of the first domain and the object graph of the second domain, obtaining a graph decoding weight of the first domain, and calling the interest alignment model to reconstruct an object graph of the first domain based on the graph decoding weight of the first domain and the fused feature representation of each object; and obtaining a graph decoding weight of the second domain, and calling the interest alignment model to reconstruct an object graph of the second domain based on the graph decoding weight of the second domain and the fused feature representation of each object are supported. In other words, the embodiments of this disclosure support reconstructing a single-domain object graph by using a graph decoder, to predict, based on the object graph, whether two objects generate interaction data for the same resource data in the single domain. If two objects generate interaction data for the same resource data, there is a connection edge between the two objects in the object graph. In this case, it is considered that the two objects have similar interests or hobbies. Therefore, it is expected that the object feature representations of the two objects are closer (that is, the embedding vectors are closer in distance).

Each domain corresponds to a different graph decoder, and specifically, graph decoding weights embodied in the graph decoders are different. A graph decoder is represented as p(Â|H_{U}, W), and a formula for reconstructing an object graph of a corresponding domain based on the fused feature representations of the objects and graph decoders corresponding to different domains is as follows:

p(\hat{A}|H_{U}, W)=sigmoid(H_{U}·WH_{U}^{T}) (7)

where W∈R^{D×D} is a weight of the graph decoder; D is an embedding dimension (that is, a dimension of a feature representation); and Â is a second interest relationship between the objects in the object graph reconstructed for the domain. Graph reconstruction is a binary classification task, that is, the reconstructed object graph includes two cases: a connection between objects and a non-connection between objects. When the second interest relationship exists between any two objects, there is a connection edge between the two objects in the object graph. In this case, it is determined that in Â, âᵤᵢᵤⱼ=1 for the two objects. On the contrary, when the second interest relationship does not exist between any two objects, there is no connection edge between the two objects in the object graph. In this case, it is determined that in Â, âᵤᵢᵤⱼ=0 for the two objects.

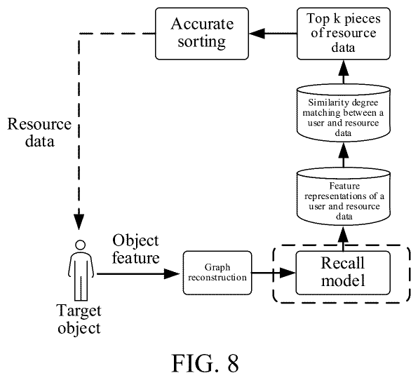

As shown in FIG. 8, After the fused feature representation of the object is inputted into a graph decoder corresponding to the first domain, an object graph G_{S} of the first domain may be reconstructed. By comparing the object resource graph and the object graph of the first domain, it can be learned that a second-order relationship between the objects in the first domain may be converted into a first-order relationship (that is, a meta path in the object resource graph: object-first resource data-object is converted into a meta path in the object graph: object-object, where the meta path may be a specific path connecting two or more nodes, and may be used to describe a composite relationship between the nodes, and different meta paths express different meanings), to describe an interest similarity between two objects in the first domain. Similarly, after the fused feature representation of the object is inputted into a graph decoder corresponding to the second domain, an object graph G_{T} of the second domain may be reconstructed. For related content of the object graph G_{T}, reference may be made to the foregoing related descriptions for the object graph G_{S}. Details are not described herein again.

s33: Align the object graph of the first domain with the object resource graph of the first domain, and align the object graph of the second domain with the object resource graph of the second domain, to implement intra-domain alignment processing. Specifically, after the object graph of the first domain and the object graph of the second domain are reconstructed based on the foregoing operations, using the object graphs as a predicted object-to-object relationship and using object resource graphs of corresponding domains as a true object-to-object relationship are supported, to train the interest alignment model according to a difference between the true object-to-object relationship and the predicted object-to-object relationship.

As an example, an intra-domain alignment loss of the first domain is obtained based on a difference between the object graph of the first domain and the corresponding object resource graph; and an intra-domain alignment loss of the second domain is obtained based on a difference between the object graph of the second domain and the corresponding object resource graph. Then, considering that there are object graphs of a plurality of domains, the intra-domain alignment loss of the first domain and the intra-domain alignment loss of the second domain are merged to obtain an intra-domain alignment loss of the interest alignment model, and the intra-domain alignment loss is used as the second loss. As described above, if the graph reconstruction is a binary classification task, using the binary classification cross-entropy loss as the graph reconstruction loss is supported; and the intra-domain alignment loss of the interest alignment model constructed with a plurality of domains (that is, the first domain and the second domain) is:

Lᵢₙₜᵣₐ=Lᵣ^{S}+Lᵣ^{T} (8)

where Lᵣ^{S} is an alignment loss of the first domain, and Lᵣ^{T} is an alignment loss of the second domain. Lᵣ^{S} and Lᵣ^{T} are respectively represented as:

Lᵣ^{S}=loss(A^{S}, Â^{S})=−Σ_{(ui,uj)∈A}_{^{S}}(aᵤᵢᵤⱼ^{S} logâᵤᵢᵤⱼ^{S}+(1−aᵤᵢᵤⱼ^{S}) log(1−âᵤᵢᵤⱼ^{S})) (9)

Lᵣ^{T}=loss(A^{T}, Â^{T})=−Σ_{(ui,uj)∈A}_{^{T}}(aᵤᵢᵤⱼ^{T} logâᵤᵢᵤⱼ^{T}+(1−aᵤᵢᵤⱼ^{T}) log(1−âᵤᵢᵤⱼ^{T}) (10)

where âᵤᵢᵤⱼ^{S} represents a connection between an object ui and an object uj in the reconstructed object graph of the first domain. If there is a connection edge between the object ui and the object uj in the object graph of the first domain, âᵤᵢᵤⱼ^{S}=1; otherwise, âᵤᵢᵤⱼ^{S}=0. Similarly, aᵤᵢᵤⱼ^{S} represents a connection between the object ui and the object uj in the object resource graph of the first domain. If there is a connection edge between the object ui and the object uj in the object resource graph of the first domain, aᵤᵢᵤⱼ^{S}=1; otherwise, aᵤᵢᵤⱼ^{S}=0. âᵤᵢᵤⱼ^{T} represents a connection between an object ui and an object uj in the reconstructed object graph of the second domain. If there is a connection edge between the object ui and the object uj in the object graph of the second domain, âuiuj^{T}=1; otherwise, âᵤᵢᵤⱼ^{T}=0. Similarly, aᵤᵢᵤⱼ^{T} represents a connection between the object ui and the object uj in the object resource graph of the second domain. If there is a connection edge between the object ui and the object uj in the object resource graph of the second domain, aᵤᵢᵤⱼ^{T}=1; otherwise, aᵤᵢᵤⱼ^{T}=0.

Based on the above, based on the specific implementation processes shown in operations s31 to s33, an intra-domain alignment loss of the interest alignment model may be constructed.

Considering that the data set (or the first domain data and the second domain) includes a large quantity of objects and resource data, to reduce computational complexity, the embodiments of this disclosure support dividing single-domain domain data into a plurality of data subsets (batches), where each data subset includes part of the objects and the resource data, so that object graphs of some object nodes can be constructed instead of constructing object graphs based on all the objects, thereby reducing computational complexity and improving model training efficiency and speed. For example, assuming that one data subset (batch) includes n objects, n≤ N, and N is the quantity of all the objects, the computational complexity can be reduced from O(N²) to O(N/n×n²)=O(N×n) compared with constructing object graphs based on all the N objects.

In some embodiments, the interest alignment processing includes cross-domain alignment processing and intra-domain alignment processing, and the calling the interest alignment model to perform the following processing: performing interest alignment processing between the first domain and the second domain based on the first domain feature representation and the second domain feature representation in operation 303 may be implemented through the following technical solution: calling the interest alignment model to perform the following processing: performing cross-domain alignment processing between the first domain and the second domain based on the first domain feature representation and the second domain feature representation; and calling the interest alignment model to perform the following processing: performing intra-domain alignment processing between the first domain and the second domain based on the first domain feature representation and the second domain feature representation.

For an implementation of performing cross-domain alignment processing between the first domain and the second domain based on the first domain feature representation and the second domain feature representation herein, reference may be made to the implementation of operation s21 and operation s22. For the performing intra-domain alignment processing between the first domain and the second domain based on the first domain feature representation and the second domain feature representation herein, reference may be made to the implementation of operation s31 to operation s33.

In some embodiments, obtaining a cross-domain alignment loss corresponding to the cross-domain alignment processing, and obtaining an intra-domain alignment loss corresponding to the intra-domain alignment processing; and forming the second loss by using the cross-domain alignment loss and the intra-domain alignment loss.

S304: Train the interest alignment model according to a direction of reducing a first loss of the feature extraction process and a loss of the interest alignment processing process.

It can be learned from the foregoing descriptions that, the overall learning objective of the model training method provided in the embodiments of this disclosure may be divided into three parts: a) Recommendation targeted learning in the second domain. That is to say, an interest or a preference of an object in the second domain is learned according to the object interaction data between the object and the second resource data. Under the targeted learning, a first loss of the interest alignment model may be constructed. b) Cross-domain interest alignment targeted learning. That is to say, an object interest similarity degree in the first domain with rich object interaction data is migrated to the second domain with sparse object interaction data, and the object interest similarity degree of the second domain is aligned with that of the first domain, thereby achieving the objective of guiding interest learning of the second domain. Under the targeted learning, a cross-domain alignment loss of the interest alignment model may be constructed. c) Intra-domain interest alignment targeted learning. That is to say, interests or preferences of objects in a domain are aligned using a graph decoding target, to make object feature representations of the objects with similar interests in the domain closer. Under the targeted learning, an intra-domain alignment loss of the interest alignment model may be constructed.

A loss in a feature extraction process may refer to the first loss of the interest alignment model mentioned above, and a loss in an interest alignment processing process may include at least one of a cross-domain alignment loss and an intra-domain alignment loss. According to different modules included in the interest alignment model, processes of training the interest alignment model according to a direction of reducing a first loss of the feature extraction process and a loss of the interest alignment processing process are different.

The interest alignment model may include only a single-domain feature extraction module and a cross-domain alignment module. Under this implementation, a process of training the interest alignment model according to a direction of reducing a first loss of the feature extraction process and a loss of the interest alignment processing process may include: jointly training the interest alignment model by using the first loss of the interest alignment model and the cross-domain alignment loss of the interest alignment model that are obtained based on the foregoing operations. More specifically, the first loss of the interest alignment model and the cross-domain alignment loss of the interest alignment model are added to obtain a target loss of the interest alignment model; and the interest alignment model is trained according to a direction in which the target loss is reduced. A formula for calculating the target loss is as follows:

L=L_{rec}^{T}+Lᵢₙₜₑᵣ (11)

L represents the overall loss of the interest alignment model, L_{rec}^{T} represents the first loss of the interest alignment model with respect to the second domain, and Linter represents the cross-domain alignment loss of the interest alignment model.

The interest alignment model may include only a single-domain feature extraction module and an intra-domain alignment module. Under this implementation, a process of training the interest alignment model according to a direction of reducing a first loss of the feature extraction process and a loss of the interest alignment processing process may include: jointly training the interest alignment model by using the first loss of the interest alignment model and the intra-domain alignment loss of the interest alignment model that are obtained based on the foregoing operations. More specifically, the first loss of the interest alignment model and the intra-domain alignment loss of the interest alignment model are added to obtain a target loss of the interest alignment model; and the interest alignment model is trained according to a direction in which the target loss is reduced. A formula for calculating the target loss is as follows:

L=L_{rec}^{T}+Lᵢₙₜᵣₐ (12)

Lᵢₙₜᵣₐ represents the intra-domain alignment loss of the interest alignment model.

The interest alignment model may include a single-domain feature extraction module, a cross-domain alignment module, and an intra-domain alignment module. Under this implementation, a process of training the interest alignment model according to a direction of reducing a first loss of the feature extraction process and a loss of the interest alignment processing process may include: jointly training the interest alignment model by using the first loss of the interest alignment model, the cross-domain alignment loss of the interest alignment model, and the intra-domain alignment loss of the interest alignment model that are obtained based on the foregoing operations. More specifically, the first loss, the cross-domain alignment loss, and the intra-domain alignment loss of the interest alignment model are added to obtain a target loss of the interest alignment model; and the interest alignment model is trained according to a direction in which the target loss is reduced. A formula for calculating the target loss is as follows:

L=L_{rec}^{T}+Lᵢₙₜₑᵣ+Lᵢₙₜᵣₐ (13)

It can be learned that, the embodiments of this disclosure support training of the interest alignment model in a joint training manner, specifically adjusting model parameters of modules included in the interest alignment model, so that prediction performance of the interest alignment model having the model parameters adjusted is more accurate. There is rich object interaction data in the first domain, while there is little object interaction data in the second domain, and the embodiments of this disclosure aim to guide learning in the second domain by using the object interaction data in the first domain. Therefore, in a process of training the interest alignment model according to a descending direction of the first loss of the feature extraction process and the loss of the interest alignment processing process, it is supported that the attention similarity degree distribution P of the first domain is used as an anchor, and the gradient back-propagation for the first feature extraction module based on the cross-domain alignment loss is truncated, that is, there is no need to adjust the parameter of the first feature extraction module based on the cross-domain alignment loss. However, the embodiments of this disclosure still support fine-tuning the first domain feature extraction module based on the intra-domain alignment loss, so that the first domain feature representation of the first domain can contribute to the first loss of the second domain.

The embodiments of this disclosure fully consider an interest similarity degree between objects, and support training of the interest alignment model in a manner of aligning the interest similarity degree between the objects, so that even when the interest alignment model is applied to a domain with little interaction data, an accurate feature representation can still be produced for an object. For example, considering that there is much interaction data in the first domain, the first domain feature representation extracted based on rich interaction data is more accurate. Therefore, the interest alignment model is trained in a manner of aligning an interest similarity degree between two objects in the second domain with little interaction data with an interest similarity degree between the two objects in the first domain with much interaction data. It can be ensured that the trained interest alignment model can still produce a feature representation with high accuracy for an object even when the interaction data in the second domain is little, so that the resource data recommended to the object based on the accurate feature representation satisfies the personalized needs of the object, and an accurate recommendation of resources is implemented. In the embodiments of this disclosure, a manner of jointly training the interest alignment model by using the first loss of the feature extraction process and the loss of the interest alignment processing process can enrich an overall learning objective of the interest alignment model, and ensure performance of the interest alignment model through multi-objective learning.

The embodiment shown in FIG. 3 mainly describes a model training part of the interest alignment model in detail. The following describes a model application part of the interest alignment model. In a specific implementation, after the trained interest alignment model is obtained based on the foregoing operations, the embodiments of this disclosure support a case that the trained interest alignment model is deployed into the resource recommendation platform, and specifically is applied to a resource recall stage of the resource recommendation platform. Therefore, the interest alignment model may also be referred to as a resource recall model. The resource recall stage is mainly to quickly select part of resource data of interest to an object from a massive resource database, to accurately sort the part of resource data subsequently and make a recommendation to the object. For an example of a schematic flowchart of applying the interest alignment model to perform model application (that is, resource recommendation), reference may be made to FIG. 8. As shown in FIG. 8, when a target object (for example, any object) has a resource distribution requirement, an object feature (or attribute information, such as age, gender, or other information) of the target object may be obtained, and an object resource graph is constructed based on interaction data between the target object and another object in the resource recommendation platform; and then, in a resource recall stage, the interest alignment model trained in this embodiment of this disclosure is used to generate a feature representation for the target object and a feature representation for resource data in the resource recommendation platform. Matching is performed between the feature representation of the target object and a feature representation of each piece of resource data. Specifically, a similarity degree between the feature representation of the target object and the resource data is calculated, and then, according to a similarity degree result, a plurality of pieces of resource data are selected into a candidate pool for fine ranking, for use in a subsequent sorting stage.

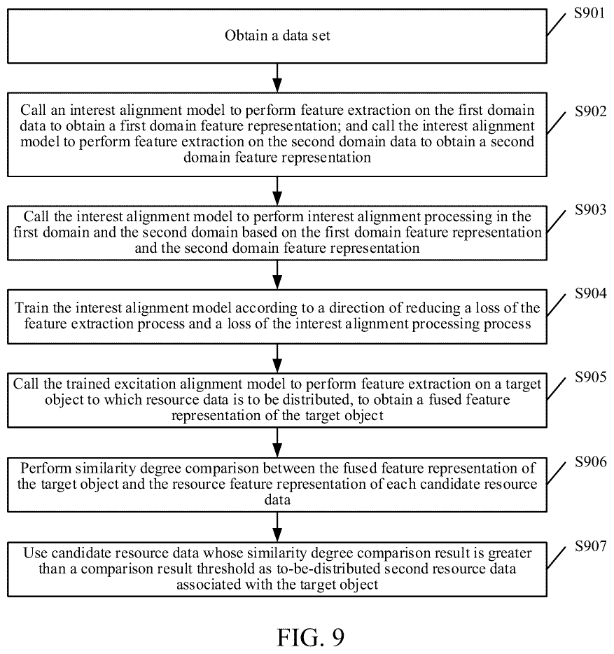

FIG. 9 is a schematic flowchart of another model training method according to an embodiment of this disclosure. The model training method may be performed by the foregoing electronic device. The method may include, but is not limited to, operations S901 to S907.

S901: Obtain a data set.

S902: Call an interest alignment model to perform feature extraction on the first domain data to obtain a first domain feature representation; and call the interest alignment model to perform feature extraction on the second domain data to obtain a second domain feature representation.

S903: Call the interest alignment model to perform interest alignment processing in the first domain and the second domain based on the first domain feature representation and the second domain feature representation.

S904: Train the interest alignment model according to a direction of reducing a first loss of the feature extraction process and a loss of the interest alignment processing process.

For the specific implementation processes shown in operations S901 to S904, reference may be made to the related descriptions of the specific implementation processes shown in operations S301 to S304 in the foregoing embodiment shown in FIG. 3. Details are not described herein again.

S905: Call the trained interest alignment model to perform feature extraction on a target object to which resource data is to be distributed, to obtain a fused feature representation of the target object.

After the trained interest alignment model is deployed to the resource recommendation platform, if the target object to which the resource data is to be distributed exists in the resource recommendation platform, for example, the target object is an object that has just been registered with the resource recommendation platform, an object attribute of the target object to which the resource data is to be distributed may be obtained. The object attribute herein may include relevant attribute information (such as a set nickname, an age, a gender, or a selected resource type label) inputted when the target object registers with the resource recommendation platform. Then, the trained interest alignment model is called to perform feature extraction based on the object attribute of the target object, to obtain a fused feature representation of the target object.

Specifically, a first feature extraction module included in the interest alignment model is called to predict a first object feature representation of the target object in the first domain, and a second feature extraction module included in the interest alignment model is called to predict a second object feature representation of the target object in the second domain. Then, the first object feature representation and the second object feature representation of the target object are fused to obtain a fused feature representation of the target object. For a specific implementation process in which the first feature extraction module predicts the first object feature representation of the target object (or, the second feature extraction module predicts the second object feature representation of the target object), reference may be made to the related descriptions in the foregoing embodiment shown in FIG. 3. Details are not described herein again.

S906: Perform similarity degree comparison between the fused feature representation of the target object and the resource feature representation of each candidate resource data.

S907: Use candidate resource data whose similarity degree comparison result is greater than a comparison result threshold as to-be-distributed second resource data associated with the target object.

In operation S906 and operation S907, a fused feature representation of the target object to which the resource data is to be distributed may be obtained based on the foregoing operations. The fused feature representation may be configured for representing an attribute or a feature of the target object (for example, configured for indicating that the target object is interested in a specific resource data type). Then, a resource feature representation of the candidate resource data to be distributed in the second domain may be obtained. The resource feature representation of any candidate resource data may also be configured for representing an attribute or a feature of the candidate resource data (for example, configured for representing a trigger status of the candidate resource data within historical time).

It is considered that candidate resource data whose resource feature representation is closer to the fused feature representation of the target object is more likely to be resource data in which the target object is interested. Therefore, performing similarity degree matching between the fused feature representation of the target object and the resource feature representation of each candidate resource data is supported, to obtain a similarity degree comparison result between the target object and each candidate resource data. The purpose of similarity degree matching is to find candidate resource data close to the fused feature representation of the target object. Finally, candidate resource data whose similarity degree comparison result satisfies a resource recommendation rule is used as to-be-distributed resource data associated with the target object. When the interest alignment model is deployed in the resource recall stage of the resource recommendation platform, the candidate resource data with the similarity degree comparison result greater than the comparison result threshold may be used as to-be-distributed resource data to be placed into a candidate pool for fine ranking, to facilitate subsequent fine ranking and recommendation. The resource recommendation rule may be customized by a service person according to a service requirement. For example, the resource recommendation rule includes: using candidate resource data whose similarity degree comparison result is greater than a comparison result threshold as to-be-distributed resource data associated with the target object. For another example, the resource recommendation rule includes: performing sorting in descending order of result values, and using top k pieces of candidate resource data as the to-be-distributed resource data associated with the target object; and so on. Specific content of the resource recommendation rule is not limited in the embodiments of this disclosure.

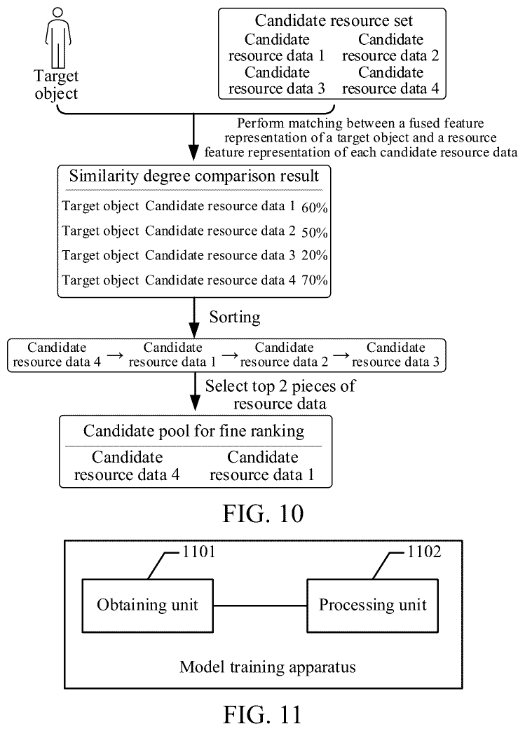

For an example schematic diagram of performing matching between a fused feature representation of a target object and a resource feature representation of each candidate resource data, Reference may be made to FIG. 10. As shown in FIG. 10, to-be-distributed candidate resource data of a second domain includes candidate resource data 1, candidate resource data 2, candidate resource data 3, and candidate resource data 4. It is assumed that a similarity degree comparison result between the fused feature representation of the target object and resource feature data of the candidate resource data 1 is 60% (or in the form of a numerical value such as a score or a decimal), a similarity degree comparison result between the fused feature representation of the target object and resource feature data of the candidate resource data 2 is 50%, a similarity degree comparison result between the fused feature representation of the target object and resource feature data of the candidate resource data 3 is 20%, and a similarity degree comparison result between the fused feature representation of the target object and resource feature data of the candidate resource data 4 is 70%. If the resource recommendation rule includes: performing sorting in descending order of result values, and using top k (k=2) pieces of candidate resource data as the to-be-distributed resource data associated with the target object, a ranking among the four pieces of candidate resource data may be obtained: candidate resource data 4→candidate resource data 1→candidate resource data 2→candidate resource data 3. Then, the candidate resource data 4 and the candidate resource data 1 that are top in the ranking may be used as the to-be-distributed resource data associated with the target object.

In actual application, the interest alignment model trained in the embodiments of this disclosure is deployed into a recall module of the resource recommendation platform, and may be configured to make resource recommendations to millions of online objects in the resource recommendation platform. For a result of evaluating a model effect of the interest alignment model by using an important index through which the industry measures whether a model makes an accurate recommendation, reference may be made to Table 1.

TABLE 1

| | Evaluation index | | | | | | |
|---|---|---|---|---|---|---|---|
| | | | | | | Viewing | |
| | Uctr180 | Uctr60 | Uctr30 | Pctr60 | Pctr30 | duration | dau |
| Increase | +1.543% | +1.196% | +1.065% | +1.775% | +0.593% | +1.214% | +1.246% |
| magnitude | | | | | | | |

In Table 1, the user-click-through-rate may be referred to as a “Uctr” for short. The evaluation index is obtained by comparing the quantity of objects having a click-through behavior with the quantity of objects accessing resource data. For example, after resource data is recommended by using the interest alignment model provided in this embodiment of this disclosure, the quantity of objects accessing the resource data is 100, and there are 13 users with a click-through behavior on the resource data. In this case, the Uctr is 13/100*% =13%. UctrX represents an increase magnitude by which a video is clicked when video playing duration is X seconds in a video recommendation scenario. As shown in Table 1, a value of X may be 180, 60, or 30. Petr may be referred to as a “page-click-through-rate”. Daily-active-users may be referred to as “dau” for short, and may be configured for reflecting a status of active objects per day in the resource recommendation platform. Based on the above, the resource recommendation platform having the interest alignment model trained in the embodiments of this disclosure deployed therein can generate object feature representations for objects more accurately, so as to accurately recommend resource data to the objects, thereby driving the promotion of the resource recommendation platform.

In this embodiment of this disclosure, related data such as user information is involved. When this embodiment of this disclosure is applied to specific products or technologies, user permission or consent needs to be obtained, and collection, use, and processing of relevant data need to comply with relevant laws, regulations, and standards of relevant countries and regions.

The method in the embodiments of this disclosure is described in detail above. To facilitate better implementation of the method in the embodiments of this disclosure, correspondingly, the following provides an apparatus in the embodiments of this disclosure.

FIG. 11 is a schematic structural diagram of a model training apparatus according to an embodiment of this disclosure. The model training apparatus may be a computer-executable instruction (including program code) running in an electronic device. The model training apparatus may be configured to perform some or all of the operations in the method embodiments shown in FIG. 3 and FIG. 9. The model training apparatus includes the following units: an obtaining unit 1101, configured to obtain a data set, the data set including first domain data and second domain data, the first domain data including at least one object and first resource data of interest to each object in a first domain, and the second domain data including the at least one object and second resource data of interest to each object in a second domain; and a processing unit 1102, configured to: call an interest alignment model to perform feature extraction on the first domain data to obtain a first domain feature representation; and call the interest alignment model to perform feature extraction on the second domain data to obtain a second domain feature representation. The processing unit 1102 is further configured to call the interest alignment model to perform the following processing: performing interest alignment processing between the first domain and the second domain based on the first domain feature representation and the second domain feature representation. The processing unit 1102 is further configured to train the interest alignment model according to a direction in which a first loss and a second loss are reduced, to obtain a trained interest alignment model. The first loss is a loss corresponding to the feature extraction, the second loss is a loss corresponding to the interest alignment processing, and the trained interest alignment model is configured for making a resource data recommendation to a target object in the second domain.

In some embodiments, the processing unit 1102 is further configured to: construct an object resource graph of the first domain based on the first domain data, the object resource graph of the first domain being a graph in which each object and each first resource data are nodes and a first interest relationship between the object and the first resource data is a connection edge; call the interest alignment model to perform graph encoding processing on the object resource graph of the first domain to obtain a first object feature representation of each object and a first resource feature representation of each first resource data; and form the first domain feature representation by using the first object feature representation of each object and the first resource feature representation of each first resource data.

In some embodiments, the processing unit 1102 is further configured to: construct an object resource graph of the second domain based on the second domain data, the object resource graph of the second domain being a graph in which each object and each second resource data are nodes and a second interest relationship between the object and the second resource data is a connection edge; call the interest alignment model to perform graph encoding processing on the object resource graph of the second domain to obtain a second object feature representation of each object and a second resource feature representation of each second resource data; and form the second domain feature representation by using the second object feature representation of each object and the second resource feature representation of each second resource data.

In some embodiments, any one of the at least one object is represented as a training object; and the processing unit 1102 is further configured to: obtain an initial feature representation of the training object in the second domain and an initial feature representation of each second resource data of interest to the training object; call the interest alignment model to calculate a correlation degree between the training object and each second resource data of interest to the training object according to the initial feature representation of the training object and the initial feature representation of each second resource data of interest to the training object; and obtain a second object feature representation of the training object based on the correlation degree between the training object and each second resource data of interest to the training object, the initial feature representation of the training object in the second domain, and the initial feature representation of each second resource data of interest to the training object.

In some embodiments, the data set includes a true attention degree of each object to corresponding second resource data of interest; and a process of obtaining the first loss of the feature extraction process includes: fusing the first object feature representation and the second object feature representation of each object to obtain a fused feature representation of each object; performing a splicing operation on the fused feature representation of each object and the second resource feature representation of the second resource data of interest to the corresponding object to obtain a predicted attention degree of each object to the corresponding second resource data of interest; and constructing the first loss of the interest alignment model based on a difference between the true attention degree of each object to the corresponding second resource data of interest and the predicted attention degree.

In some embodiments, the interest alignment processing includes cross-domain alignment processing, the first domain feature representation includes a first object feature representation of each object in the first domain data, and the second domain feature representation includes a second object feature representation of each object in the second domain data; and the processing unit 1102 is further configured to: call the interest alignment model to determine a first attention similarity degree between each two objects in the first domain based on the first object feature representation of each object; call the interest alignment model to determine a second attention similarity degree between each two objects in the second domain based on the second object feature representation of each object; and align the second attention similarity degree between the two objects in the second domain with the first attention similarity degree between the corresponding two objects in the first domain.

In some embodiments, the processing unit 1102 is further configured to: perform a distance operation on the first object feature representations of each two objects of a plurality of objects to obtain distance information between the first object feature representations of each two objects; and perform probability conversion on the distance information between the first object feature representations of each two objects, to obtain the first attention similarity degree between each two objects.

In some embodiments, a process of obtaining the loss of the interest alignment processing process includes: determining an attention similarity degree distribution of the first domain based on the first attention similarity degree between each two objects in the first domain; determining an attention similarity degree distribution of the second domain based on the second attention similarity degree between each two objects in the second domain; and constructing a cross-domain alignment loss of the interest alignment model based on a difference between the attention similarity degree distribution of the first domain and the attention similarity degree distribution of the second domain, and using the cross-domain alignment loss as the second loss.

In some embodiments, the processing unit 1102 is further configured to: obtain a fused feature representation of each object, an object resource graph of the first domain, and an object resource graph of the second domain; call the interest alignment model to perform graph decoding processing regarding the first domain and graph decoding processing regarding the second domain on the fused feature representation of each object, to obtain an object graph of the first domain and an object graph of the second domain, where an object graph is a graph in which each object is used as a node and a second interest relationship between objects is used as a connection edge; and align the object graph of the first domain with the object resource graph of the first domain, and align the object graph of the second domain with the object resource graph of the second domain.

In some embodiments, the processing unit 1102 is further configured to: obtain a graph decoding weight of the first domain, and calling the interest alignment model to reconstruct an object graph of the first domain based on the graph decoding weight of the first domain and the fused feature representation of each object; and obtain a graph decoding weight of the second domain, and calling the interest alignment model to reconstruct an object graph of the second domain based on the graph decoding weight of the second domain and the fused feature representation of each object.

In some embodiments, a process of obtaining the second loss of the interest alignment processing process includes: obtaining an intra-domain alignment loss of the first domain based on a difference between the object graph of the first domain and the corresponding object resource graph; obtaining an alignment loss of the second domain based on a difference between the object graph of the second domain and the corresponding object resource graph; and merging the alignment loss of the first domain and the alignment loss of the second domain to obtain an intra-domain alignment loss of the interest alignment model, and using the intra-domain alignment loss as the second loss.

In some embodiments, the interest alignment processing includes cross-domain alignment processing and intra-domain alignment processing, and the processing unit 1102 is further configured to: call the interest alignment model to perform the following processing: performing cross-domain alignment processing between the first domain and the second domain based on the first domain feature representation and the second domain feature representation; and call the interest alignment model to perform the following processing: performing intra-domain alignment processing between the first domain and the second domain based on the first domain feature representation and the second domain feature representation.

In some embodiments, a process of obtaining the second loss of the interest alignment processing process includes: obtaining a cross-domain alignment loss corresponding to the cross-domain alignment processing, and obtaining an intra-domain alignment loss corresponding to the intra-domain alignment processing; and forming the second loss by using the cross-domain alignment loss and the intra-domain alignment loss.

In some embodiments, the interest alignment model includes a first feature extraction module, a second feature extraction module, a cross-domain alignment module, and an intra-domain alignment module; the first feature extraction module is configured to perform feature extraction on the first domain data; the first feature extraction module is obtained through pre-training; the second feature extraction module is configured to perform feature extraction on the second domain data; the cross-domain alignment module is configured to perform interest alignment processing between the second attention similarity degree between the two objects in the second domain and the first attention similarity degree between the corresponding two objects in the first domain; and the intra-domain alignment module is configured to perform interest alignment processing between the object graph of the first domain and the object resource graph of the first domain, and perform interest alignment processing between the object graph of the second domain and the object resource graph of the second domain.

In some embodiments, the loss of the interest alignment processing process includes: a cross-domain alignment loss obtained through the cross-domain alignment, and an intra-domain alignment loss obtained through the intra-domain alignment; and the processing unit 1102 is further configured to: add the first loss of the interest alignment model, the cross-domain alignment loss, and the intra-domain alignment loss, to obtain a target loss of the interest alignment model; and train the interest alignment model according to a direction in which the target loss is reduced, where in a process of training the interest alignment model according to the direction in which the target loss is reduced, training of the first feature extraction module based on the cross-domain alignment loss is truncated.

In some embodiments, the processing unit 1102 is further configured to: obtain an object attribute of a target object to which resource data is to be distributed and a resource feature representation of each candidate resource data to be distributed in the second domain; call the trained interest alignment model to perform feature extraction based on the object attribute of the target object, to obtain a fused feature representation of the target object; perform similarity degree comparison between the fused feature representation of the target object and the resource feature representation of each candidate resource data, to obtain a similarity degree comparison result between the target object and each candidate resource data; and use candidate resource data whose similarity degree comparison result meets a resource recommendation rule as to-be-distributed second resource data associated with the target object.

In some embodiments, the units in the model training apparatus shown in FIG. 11 may be separately or entirely combined into one or several other units, or one (or more) of the units may be further divided into a plurality of units having smaller functions, which can implement the same operation without affecting the implementation of the technical effects of the embodiments of this disclosure. The foregoing units are divided based on logical functions. In actual application, a function of one unit may also be implemented by a plurality of units, or functions of a plurality of units are implemented by one unit. In other embodiments of this disclosure, the model training apparatus may also include other units. In actual application, these functions may also be implemented with assistance by other units, and may be implemented with cooperation by a plurality of units. According to another embodiment of this disclosure, a computer program (including program code) that can perform the operations involved in the corresponding methods shown in FIG. 3 and FIG. 9 may be run on a general-purpose electronic device such as a computer that includes processing elements and storage elements such as a central processing unit (CPU), a random access storage medium (RAM), and a read-only storage medium (ROM), to construct the model training apparatus shown in FIG. 11 and implement the model training method in the embodiments of this disclosure. The computer program may be recorded in, for example, a computer-readable recording medium, and may be loaded into the foregoing electronic device by using the computer-readable recording medium, and run in the electronic device.

The embodiments of this disclosure fully consider an interest similarity degree between objects, and support training of the interest alignment model in a manner of aligning the interest similarity degree between the objects, so that even when the interest alignment model is applied to a domain with little interaction data, an accurate feature representation can still be produced for an object. For example, considering that there is much interaction data in the first domain, the first domain feature representation extracted based on rich interaction data is more accurate. Therefore, the interest alignment model is trained in a manner of aligning an interest similarity degree between two objects in the second domain with little interaction data with an interest similarity degree between the two objects in the first domain with much interaction data. It can be ensured that the trained interest alignment model can still produce a feature representation with high accuracy for an object even when the interaction data in the second domain is little, so that the resource data recommended to the object based on the accurate feature representation satisfies the personalized needs of the object, and an accurate recommendation of resources is implemented. In the embodiments of this disclosure, a manner of jointly training the interest alignment model by using the first loss of the feature extraction process and the loss of the interest alignment processing process can enrich an overall learning objective of the interest alignment model, and ensure performance of the interest alignment model through multi-objective learning.

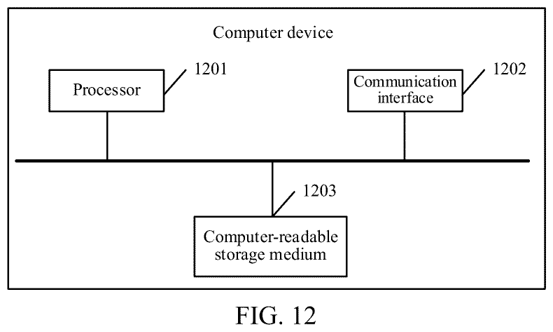

FIG. 12 is a schematic structural diagram of an electronic device according to an embodiment of this disclosure. Referring to FIG. 12, the electronic device includes a processor 1201, a communication interface 1202, and a computer-readable storage medium 1203. The processor 1201, the communication interface 1202, and the computer-readable storage medium 1203 may be connected through a bus or in another manner. The communication interface 1202 is configured to receive and transmit data. The computer-readable storage medium 1203 may be stored in a memory of the electronic device. The computer-readable storage medium 1203 is configured to store a computer program. The computer program includes program instructions. The processor 1201 is configured to execute the program instructions stored in the computer-readable storage medium 1203. The processor 1201 (or referred to as a Central Processing Unit (CPU)) is a computing core and a control core of the electronic device, and is configured to implement one or more instructions, and is specifically configured to load and execute the one or more instructions to implement a corresponding method process or a corresponding function.

An embodiment of this disclosure further provides a computer-readable storage medium (memory). The computer-readable storage medium is a memory device in an electronic device, and is configured to store a program and data. The computer-readable storage medium herein may include an internal storage medium of the electronic device, and certainly may also include an expanded storage medium supported by the electronic device. The computer-readable storage medium provides a storage space, and the storage space has a processing system of the electronic device stored therein. In addition, one or more instructions that are loaded and executed by the processor 1201 are further stored in the storage space. The instructions may be one or more computer programs (including program code). The computer-readable storage medium herein may be a high-speed RAM memory, or may be a non-volatile memory, for example, at least one magnetic disk memory, or may be at least one computer-readable storage medium remotely located from the foregoing processor.

In some embodiments, the computer-readable storage medium has one or more instructions stored therein. The processor 1201 loads and executes the one or more instructions stored in the computer-readable storage medium, to implement corresponding operations in the foregoing model training method embodiments.

An embodiment of this disclosure further provides a computer program product. The computer program product includes a computer-executable instruction. The computer-executable instruction is stored in a computer-readable storage medium. A processor of an electronic device reads the computer-executable instruction from the computer-readable storage medium, and the processor executes the computer-executable instruction, so that the electronic device performs the foregoing model training method.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

A person of ordinary skill in the art may notice that the units and algorithm operations described with reference to the embodiments disclosed in this disclosure can be implemented in electronic hardware, or a combination of computer software and electronic hardware. Whether these functions are executed in the manner of hardware or software depends on specific applications and design constraints of the technical solutions. A person skilled in the art may use different methods to implement the described functions for each particular application, but it is not to be considered that the implementation goes beyond the scope of this disclosure.

All or some of the foregoing embodiments may be implemented by using software, hardware, firmware, or any combination thereof. When software is configured for implementation, implementation may be entirely or partially performed in the form of a computer program product. The computer program product includes one or more computer-executable instructions. When the computer program instructions are loaded and executed on a computer, all or some of the processes or functions according to the embodiments of the present disclosure are produced. The computer may be a general-purpose computer, a dedicated computer, a computer network, or another programmable device. The computer-executable instruction may be stored in the computer-readable storage medium or transmitted through the computer-readable storage medium. The computer-executable instruction may be transmitted from a website, computer, server or data center to another website, computer, server or data center in a wired (for example, coaxial cable, optical fiber, or digital subscriber line (DSL)) or wireless (for example, infrared, radio, or microwave) manner. The computer-readable storage medium may be any available medium capable of being accessed by a computer or include one or more data processing devices integrated by an available medium, such as a server and a data center. The usable medium may be a magnetic medium (for example, a soft disk, a hard disk, or a magnetic tape), an optical medium (for example, a DVD), a semiconductor medium (for example, a solid state drive (SSD)), or the like.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some examples of embodiments of this disclosure which are not intended to limit the scope of this disclosure. Other embodiments shall also fall within the scope of this disclosure.

What is claimed is:

1. A method of model training, comprising:
obtaining a data set for training an interest alignment model of cross domain recommendation, the data set comprising first domain data of one or more objects in a first domain and second domain data of the one or more objects in a second domain, the first domain including first resources, the second domain including second resources, the first domain data comprising respective first resources of interest to the one or more objects, and the second domain data comprising respective second resources of interest to the one or more objects;
performing a first feature extraction on the first domain data according to the interest alignment model to obtain a first domain feature representation;
performing a second feature extraction on the second domain data according to the interest alignment model to obtain a second domain feature representation;
performing an interest alignment between the first domain and the second domain according to the interest alignment model based on the first domain feature representation and the second domain feature representation; and
training the interest alignment model in a direction that reduces at least one of a first loss and a second loss, to obtain a trained interest alignment model,
wherein:
the first loss is associated with at least one of the first feature extraction and the second feature extraction, the second loss is associated with the interest alignment, and the trained interest alignment model is configured to make a resource data recommendation to a target object in the second domain.

2. The method according to claim 1, wherein the performing the first feature extraction comprises:
constructing an object resource graph of the first domain based on the first domain data, the object resource graph of the first domain including first nodes respectively associated with the one or more objects, second nodes respectively associated with the first resources in the first domain, and connection edges connecting the first nodes with the second nodes according to the respective first resources of interest to the one or more objects in the first domain;
performing a graph encoding on the object resource graph of the first domain according to the interest alignment model to obtain respective first object feature representations of the one or more objects and respective first resource feature representations of the first resources; and
forming the first domain feature representation based on the respective first object feature representations of the one or more objects and the respective first resource feature representations of the first resources.

3. The method according to claim 1, wherein the performing the second feature extraction comprises:
constructing an object resource graph of the second domain based on the second domain data, the object resource graph of the second domain including first nodes respectively associated with the one or more objects, second nodes respectively associated with the second resources in the second domain, and connection edges connecting the first nodes with the second nodes according to the respective second resources of interest to the one or more objects in the second domain;
performing a graph encoding on the object resource graph of the second domain according to the interest alignment model to obtain respective second object feature representations of the one or more objects and respective second resource feature representations of the second resources; and
forming the second domain feature representation based on the respective second object feature representations of the one or more objects and the respective second resource feature representations of the second resources.

4. The method according to claim 3, wherein the one or more objects are training objects; and the performing the graph encoding comprises:
obtaining an initial feature representation of a first training object in the one or more objects in the second domain and respective initial feature representations of the second resources to the first training object;
calculating respective correlation degrees between the first training object and the second resources according to the initial feature representation of the first training object and the respective initial feature representations of the second resources; and
determining a second object feature representation of the first training object based on the respective correlation degrees between the first training object and the second resources, the initial feature representation of the first training object in the second domain, and the respective initial feature representations of the second resources.

5. The method according to claim 3, wherein the data set comprises a true attention degree of a first object in the one or more objects to a resource in the second resources; and the method further comprises:
fusing a first object feature representation of the first object and a second object feature representation of the first object to obtain a fused feature representation of the first object;
performing a splicing operation on the fused feature representation of the first object and a second resource feature representation of the resource in the second resources to obtain a predicted attention degree of the first object to the resource in the second resources; and
constructing the first loss of the interest alignment model based on at least a difference between the true attention degree of the first object and the predicted attention degree.

6. The method according to claim 1, wherein the interest alignment comprises a cross-domain alignment, the first domain feature representation comprises respective first object feature representations of the one or more objects in the first domain data, and the second domain feature representation comprises respective second object feature representations of the one or more objects in the second domain data; and the performing the interest alignment comprises:
determining, according to the interest alignment model, first attention similarity degrees between each pair of objects in the one or more objects in the first domain based on the respective first object feature representations;
determining, according to the interest alignment model, second attention similarity degrees between each pair of objects in the one or more objects in the second domain based on the respective second object feature representations; and
aligning the second attention similarity degrees between pairs of objects in the second domain with the first attention similarity degrees between the pairs of objects in the first domain.

7. The method according to claim 6, wherein the determining the first attention similarity degrees comprises:
determining distance information between a first object and a second object in the one or more objects based on respective first object feature representations of the first object and the second object; and
converting the distance information between the first object and the second object, to obtain a first attention similarity degree, of the first attention similarity degrees, between the first object and the second object.

8. The method according to claim 6, further comprising:
determining an attention similarity degree distribution of the first domain based on the first attention similarity degrees between the pairs of objects in the first domain;
determining an attention similarity degree distribution of the second domain based on the second attention similarity degrees between the pairs of objects in the second domain; and
constructing a cross-domain alignment loss of the interest alignment model based on a difference between the attention similarity degree distribution of the first domain and the attention similarity degree distribution of the second domain, the cross-domain alignment loss being used as the second loss.

9. The method according to claim 1, wherein the interest alignment comprises intra-domain alignment, and the performing the interest alignment comprises:
obtaining respective fused feature representations of the one or more objects;
obtaining a first object resource graph of the first domain;
obtaining a second object resource graph of the second domain;
performing a graph decoding on the respective fused feature representations of the one or more objects according to the interest alignment model to obtain a first object graph of the first domain and a second object graph of the second domain;
aligning the first object graph of the first domain with the first object resource graph of the first domain; and
aligning the second object graph of the second domain with the second object resource graph of the second domain.

10. The method according to claim 9, wherein the performing the graph decoding comprises:
obtaining first graph decoding weights of the first domain;
reconstructing, according to the interest alignment model, the first object graph of the first domain based on the first graph decoding weights of the first domain and the respective fused feature representations of the one or more objects;
obtaining second graph decoding weights of the second domain; and
reconstructing, according to the interest alignment model, the second object graph of the second domain based on the second graph decoding weights of the second domain and the respective fused feature representations of the one or more objects.

11. The method according to claim 9, further comprising:
obtaining a first intra-domain alignment loss of the first domain based on a first difference between the first object graph of the first domain and the first object resource graph;
obtaining a second intra-domain alignment loss of the second domain based on a second difference between the second object graph of the second domain and the second object resource graph; and
merging the first intra-domain alignment loss of the first domain and the second intra-domain alignment loss of the second domain to obtain an intra-domain alignment loss of the interest alignment model, the intra-domain alignment loss being used as the second loss.

12. The method according to claim 1, wherein the interest alignment comprises a cross-domain alignment and an intra-domain alignment, and the performing the interest alignment comprises:
performing, according to the interest alignment model, the cross-domain alignment between the first domain and the second domain based on the first domain feature representation and the second domain feature representation; and
performing, according to the interest alignment model, the intra-domain alignment between the first domain and the second domain based on the first domain feature representation and the second domain feature representation.

13. The method according to claim 12, further comprising:
determining a cross-domain alignment loss of the cross-domain alignment;
determining an intra-domain alignment loss of the intra-domain alignment; and
determining the second loss based on the cross-domain alignment loss and the intra-domain alignment loss.

14. The method according to claim 1, wherein the interest alignment model comprises a first feature extraction module, a second feature extraction module, a cross-domain alignment module, and an intra-domain alignment module, and the method comprises:
performing the first feature extraction on the first domain data using the first feature extraction module that is pre-trained;
performing the second feature extraction on the second domain data using the second feature extraction module;
performing, using the cross-domain alignment module, a cross domain alignment between second attention similarity degrees of pairs of objects of the one or more objects in the second domain and first attention similarity degrees of the pairs of objects of the one or more objects;
performing, using the intra-domain alignment module, a first interest alignment between a first object graph of the first domain and an object resource graph of the first domain; and
performing, using the intra-domain alignment module, a second interest alignment between a second object graph of the second domain and a second object resource graph of the second domain.

15. The method according to claim 14, wherein the second loss comprises a cross-domain alignment loss associated with the cross-domain alignment module, and an intra-domain alignment loss associated with the intra-domain alignment module; and the training the interest alignment model comprises:
adding the first loss, the cross-domain alignment loss, and the intra-domain alignment loss, to obtain a target loss of the interest alignment model; and
training the interest alignment model in a direction that reduces the target loss.

16. The method according to claim 1, further comprising:
obtaining an object attribute of the target object and resource feature representations of respective candidate resources in the second domain for distributing to the target object;
performing, according to the trained interest alignment model, a feature extraction based on the object attribute of the target object, to obtain a fused feature representation of the target object;
performing similarity degree comparisons between the fused feature representation of the target object and the resource feature representations of the respective candidate resources, to obtain similarity degree comparison results associated with the respective candidate resources; and
selecting one or more candidate resources with associated similarity degree comparison results satisfying a resource recommendation rule as to-be-distributed second resource data for the target object.

17. An electronic device, comprising processing circuitry configured to:
obtain a data set for training an interest alignment model of cross domain recommendation, the data set comprising first domain data of one or more objects in a first domain and second domain data of the one or more objects in a second domain, the first domain including first resources, the second domain including second resources, the first domain data comprising respective first resources of interest to the one or more objects, and the second domain data comprising respective second resources of interest to the one or more objects;
perform a first feature extraction on the first domain data according to the interest alignment model to obtain a first domain feature representation;
perform a second feature extraction on the second domain data according to the interest alignment model to obtain a second domain feature representation;
perform an interest alignment between the first domain and the second domain according to the interest alignment model based on the first domain feature representation and the second domain feature representation; and
train the interest alignment model in a direction that reduces at least one of a first loss and a second loss, to obtain a trained interest alignment model,
wherein:
the first loss is associated with at least one of the first feature extraction and the second feature extraction, the second loss is associated with the interest alignment, and the trained interest alignment model is configured to make a resource data recommendation to a target object in the second domain.

18. The electronic device according to claim 17, wherein the processing circuitry is further configured to:
obtain an object attribute of the target object and resource feature representations of respective candidate resources in the second domain for distributing to the target object;
perform, according to the trained interest alignment model, a feature extraction based on the object attribute of the target object, to obtain a fused feature representation of the target object;
perform similarity degree comparisons between the fused feature representation of the target object and the resource feature representations of the respective candidate resources, to obtain similarity degree comparison results associated with the respective candidate resources; and
select one or more candidate resources with associated similarity degree comparison results satisfying a resource recommendation rule as to-be-distributed second resource data for the target object.

19. A non-transitory computer-readable storage medium storing instructions which when executed by at least one processor cause the at least one processor to perform:
obtaining a data set for training an interest alignment model of cross domain recommendation, the data set comprising first domain data of one or more objects in a first domain and second domain data of the one or more objects in a second domain, the first domain including first resources, the second domain including second resources, the first domain data comprising respective first resources of interest to the one or more objects, and the second domain data comprising respective second resources of interest to the one or more objects;
performing a first feature extraction on the first domain data according to the interest alignment model to obtain a first domain feature representation;
performing a second feature extraction on the second domain data according to the interest alignment model to obtain a second domain feature representation;
performing an interest alignment between the first domain and the second domain according to the interest alignment model based on the first domain feature representation and the second domain feature representation; and
training the interest alignment model in a direction that reduces at least one of a first loss and a second loss, to obtain a trained interest alignment model,
wherein:
the first loss is associated with at least one of the first feature extraction and the second feature extraction, the second loss is associated with the interest alignment, and the trained interest alignment model is configured for making a resource data recommendation to a target object in the second domain.

20. The non-transitory computer-readable storage medium according to claim 19, wherein the instructions further cause the at least one processor to perform:
obtaining an object attribute of the target object and resource feature representations of respective candidate resources in the second domain for distributing to the target object;
performing, according to the trained interest alignment model, a feature extraction based on the object attribute of the target object, to obtain a fused feature representation of the target object;
performing similarity degree comparisons between the fused feature representation of the target object and the resource feature representations of the respective candidate resources, to obtain similarity degree comparison results associated with the respective candidate resources; and
selecting one or more candidate resources with associated similarity degree comparison results satisfying a resource recommendation rule as to-be-distributed second resource data for the target object.
